(19) United States
(12) Patent Application Publication
(10) Pub. No.: US 2026/0136043 A1
(43) Pub. Date: May 14, 2026

(54) VIDEO ENCODING AND DECODING APPARATUS AND METHOD

(71) Applicant: INDUSTRY ACADEMY COOPERATION FOUNDATION OF SEJONG UNIVERSITY, Seoul (KR)

(72) Inventors: Yung Lyul LEE, Seoul (KR); Myung Jun KIM, Guri-si, Gyeonggi-do (KR); Hyeon Ju SONG, Seoul (KR); Su Yeon LIM, Namyangju-si, Gyeonggi-do (KR); Min Kyeong CHOI, Seoul (KR)

(21) Appl. No.: 19/118,339

(22) PCT Filed: Oct. 4, 2023
(86) PCT No.: PCT/KR2023/015226

§ 371 Date: Apr. 3, 2025

(30) Foreign Application Priority Data
Oct. 5, 2022 (KR) 10-2022-0126883
Oct. 14, 2022 (KR) 10-2022-0132667
Apr. 17, 2023 (KR) 10-2023-0049909
Aug. 21, 2023 (KR) 10-2023-0109205

(51) Int. Cl. H04N 19/61; H04N 19/105; H04N 19/159; H04N 19/176; H04N 19/182; H04N 19/80

(52) U.S. Cl. CPC H04N 19/61; H04N 19/105; H04N 19/159; H04N 19/176; H04N 19/182; H04N 19/80

(57) ABSTRACT

In the present disclosure, a quantization block acquired from a bitstream may be dequantized so that a secondary transform block is acquired, whether to perform secondary inverse-transform for the secondary transform block may be determined, a primary transform block may be acquired by performing the secondary inverse-transform for the secondary transform block when it is determined to perform the secondary inverse-transform, and primary inverse-transform for the primary transform block may be performed.

### TECHNICAL FIELD

The present invention relates to a video encoding and decoding device and method, and more particularly, relates to a video encoding and decoding device and method for deriving the kernel of at least one of primary transform or secondary transform and applying the kernel of derived transform to corresponding transform.

### BACKGROUND ART

Recently, the demand for multimedia data such as a video has been rapidly increasing on the Internet. However, the speed at which the bandwidth of a channel is developing is difficult to keep up with the rapidly increasing amount of multimedia data.

### DISCLOSURE

### Technical Problem

The present invention is to improve encoding efficiency of a video signal.

### Technical Solution

An encoding/decoding method of the present invention and a computer readable recording medium storing a bitstream may include dequantizing a quantization block obtained from a bitstream to obtain a secondary transform block, determining whether to perform secondary inverse transform for the secondary transform block, performing the secondary inverse transform for the secondary transform block to obtain a primary transform block when it is determined to perform the secondary inverse transform, and performing primary inverse transform for the primary transform block.

In an encoding/decoding method of the present invention and a computer readable recording medium storing a bitstream, a transform kernel of the secondary inverse transform and a transform kernel of the primary inverse transform may be specified by an index signaled from the bitstream.

In an encoding/decoding method of the present invention and a computer readable recording medium storing a bitstream, a maximum value and a configuration of the index may be different depending on whether a transform kernel applied is a one-dimensional transform kernel or a two-dimensional transform kernel.

In an encoding/decoding method of the present invention and a computer readable recording medium storing a bitstream, a transform kernel of the secondary inverse transform and a transform kernel of the primary inverse transform may include Karhunen Loeve Transform (KLT).

In an encoding/decoding method of the present invention and a computer readable recording medium storing a bitstream, an output block of at least one of the secondary inverse transform or the primary inverse transform may have a size smaller than a size of an input block.

In an encoding/decoding method of the present invention and a computer readable recording medium storing a bitstream, whether to perform the secondary transform may be determined based on at least one of a type of a transform kernel, the number of transform coefficients or a size of a block.

An encoding/decoding method of the present invention and a computer readable recording medium storing a bitstream may include dequantizing a quantization block obtained from a bitstream to obtain a primary transform block, determining a transform kernel of primary inverse transform for the primary transform block, and performing primary inverse transform for the primary transform block based on the determined transform kernel of the primary inverse transform to obtain a residual block.

An encoding/decoding method of the present invention and a computer readable recording medium storing a bitstream includes determining an intra prediction mode of a current block and interpolating a reference pixel used for the intra prediction mode, wherein the reference pixel is included in an adjacent reference block around the current block and an interpolation filter applied to the interpolation includes a 8-tap filter.

### Advantageous Effects

A video encoding and decoding device and method according to the present invention may improve encoding efficiency of a video signal by applying a suitable kernel to transform.

### DESCRIPTION OF DRAWINGS

FIG. 1 is a block diagram showing an image encoding device according to an embodiment of the present invention.

FIG. 2 is a block diagram showing an image decoding device 200 according to an embodiment of the present invention.

FIG. 3 is a diagram showing an off-line training process for deriving a transform kernel.

FIG. 4 shows a representative block obtained by obtaining a representative value and clustering.

FIG. 5 shows an embodiment in which a 1D (1 dimension) transform kernel is applied.

FIG. 6 shows an embodiment in which a 2D transform kernel is applied.

FIG. 7 is a diagram showing a transform process in an encoder.

FIG. 8 is a diagram showing an inverse transform process in a decoder.

FIG. 9 is a diagram showing a first embodiment in which a 1D transform kernel is applied by utilizing dimension reduction.

FIG. 10 is a diagram showing a second embodiment in which a 1D transform kernel is applied by utilizing dimension reduction.

FIG. 11 is a diagram showing a third embodiment in which a 1D transform kernel is applied by utilizing dimension reduction.

FIG. 12 is a diagram showing a fourth embodiment in which a 1D transform kernel is applied when the entire data is transformed without dimension reduction.

FIG. 13 is a diagram showing a first embodiment in which a 2D transform kernel is applied by utilizing dimension reduction.

FIG. 14 is a diagram showing a second embodiment in which a 2D transform kernel is applied by utilizing dimension reduction.

FIG. 15 is a diagram showing a second embodiment in which a 2D transform kernel is applied by utilizing dimension reduction.

FIG. 16 is a diagram showing a third embodiment in which a 2D transform kernel is applied by utilizing dimension reduction.

FIG. 17 shows an example in which vectors are rearranged as a 2D block.

FIG. 18 shows an embodiment in which coefficients of a rearranged block are scanned.

FIG. 19 is a diagram showing an embodiment in which a 1D transform kernel for primary transform is signaled.

FIG. 20 is a diagram showing an embodiment in which a 2D transform kernel for primary transform is signaled.

FIG. 21 is a diagram showing an embodiment in which a 1D transform kernel for secondary transform is signaled.

FIG. 22 is a diagram showing an embodiment in which a 2D transform kernel for secondary transform is signaled.

FIG. 23 shows an example in which only primary transform is applied in an encoder.

FIG. 24 shows an example in which only primary inverse transform is applied in a decoder.

FIG. 25 is a diagram for describing an example in which only some columns of MN(=M×N) columns are used.

FIG. 26 is a diagram showing a signal-dependent transform kernel size and an inverse kernel corresponding thereof.

FIG. 27 is a diagram showing scanning of one-dimensional data.

FIG. 28 is a diagram showing h[n], y[n] and z[n] for obtaining a 8-tap coefficient.

FIG. 29 shows integer reference samples used to derive a 8-tap SIF coefficient.

FIG. 30 is a diagram showing the direction and angle of an intra prediction mode.

FIG. 31 is a diagram showing the average correlation value of a reference sample for a variety of video resolution and each nTbS.

FIG. 32 shows an example of a method for selecting an interpolation filter by using frequency information.

FIG. 33 shows embodiments for 8-tap DCT interpolation filter coefficients.

FIG. 34 shows an embodiment for 8-tap smoothing interpolation filter coefficients.

FIG. 35 shows a size response at a 16/32 pixel position of 4-tap DCT-IF, 4-tap SIF, 8-tap DCT-IF and 8-tap SIF.

FIG. 36 shows a diagram related to each threshold value according to nTbS.

FIG. 37 shows the sequence name, screen size, screen rate and bit depth of a CTC video sequence for each class.

FIG. 38 shows an interpolation filter selection method and an interpolation filter applied according to a selected method to test the efficiency of a 8-tap/4-tap interpolation filter.

Table IX and Table X in FIG. 39 show a simulation result from methods A, B, C and D.

Table XI in FIG. 40 shows the ratio of a CU that applies 4-tap DCT-IF at a VVC anchor and applies 8-tap DCT-IF based on high_freq_ratio in a method proposed for all test sequences.

FIG. 41 shows an experimental result for a proposed filtering method.

### BEST MODE

The present invention may dequantize a quantization block obtained from a bitstream to obtain a secondary transform block, determine whether to perform secondary inverse transform for the secondary transform block, perform the secondary inverse transform for the secondary transform block to obtain a primary transform block when it is determined to perform the secondary inverse transform, and perform primary inverse transform for the primary transform block.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. In describing each drawing, a similar reference numeral is used for a similar element.

A term such as first, second, etc. may be used to describe a variety of elements, but the elements should not be limited by the terms. The terms are used only to distinguish one element from other elements. For example, without getting out of the scope of a right of the present disclosure, a first element may be referred to as a second element and likewise, a second element may be also referred to as a first element. A term of and/or includes a combination of a plurality of relevant described items or any item of a plurality of relevant described items.

When an element is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations.

Hereinafter, embodiments of the present disclosure is described in detail by referring to attached drawings. Hereinafter, the same reference numeral is used for the same element in a drawing and an overlapping description on the same element is omitted.

Unlike a case of using separable horizontal or vertical one-dimensional transform such as signal-independent DCT-2 (Discrete Cosine Transform-2), DCT-8 (Discrete Cosine Transform-8), DST-7 (Discrete Sine Transform-7), etc. used in video compression/reconstruction standards, the present invention proposes a method for obtaining data after transform when using signal-dependent KL (Karhunen-Loeve) or SVD (Singular Value Decomposition) transform using covariance and correlation of each two-dimensional block (here, a block means a residual signal block or a transformed block) and a method for rearranging and scanning a transform coefficient accordingly.

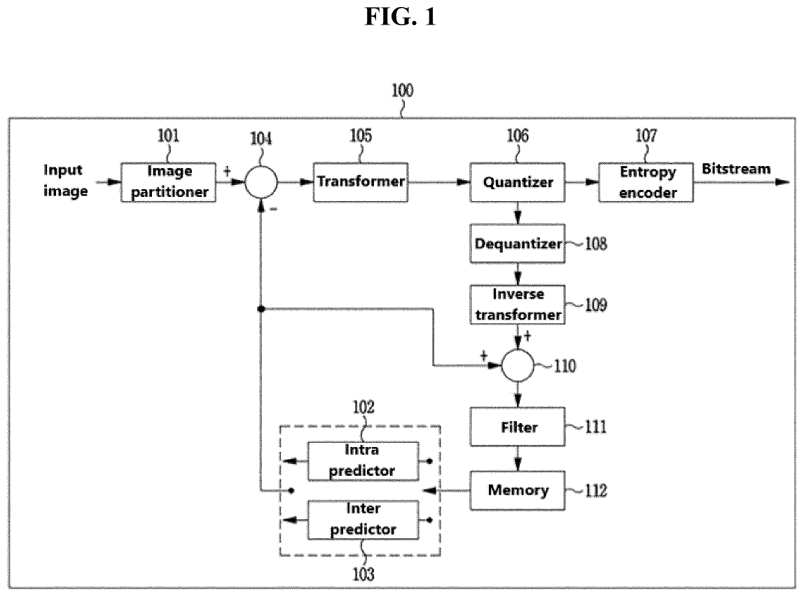

FIG. 1 is a block diagram showing an image encoding device according to an embodiment of the present invention.

Referring to FIG. 1, an image encoding device 100 may include an image partitioner 101, an intra predictor 102, an inter predictor 103, a subtractor 104, a transformer 105, a quantizer 106, an entropy encoder 107, a dequantizer 108, an inverse transformer 109, an adder 110, a filter 111 and a memory 112.

Each construction unit shown in FIG. 1 is independently shown to represent different characteristic functions in an image encoding device, and does not mean that each construction unit is composed of separate hardware or a single software unit. In other words, each construction unit is included by being listed as each construction unit for convenience of explanation, and at least two construction units among each construction unit may be combined to form one construction unit or one construction unit may be divided into a plurality of construction units to perform a function, and an integrated embodiment and a separated embodiment of each construction unit are also included in the scope of a right of the present invention as long as they do not deviate from the essence of the present invention.

In addition, some elements are not a necessary element that performs an essential function in the present invention, and may be an optional element only for improving performance. The present invention may be implemented by including only a construction unit necessary for implementing the essence of the present invention excluding an element used only for improving performance, and a structure including only a necessary element excluding an optional element used only for improving performance is also included in the scope of a right of the present invention.

An image partitioner 100 may partition an input image into at least one block. In this case, an input image may have various shapes and sizes such as a picture, a slice, a tile, a segment, etc. A block may mean a coding unit (CU), a prediction unit (PU) or a transform unit (TU). The partition may be performed based on at least one of a quadtree or a binary tree. A quadtree is a method for partitioning a higher block into four lower blocks where a width and a height are half those of a higher block. A binary tree is a method for partitioning a higher block into two lower blocks where any one of a width or a height is half that of a higher block. Through the above-described binary tree-based partition, a block may have a non-square shape as well as a square shape.

Predictors 102 and 103 may include an inter predictor 103 that performs inter prediction and an intra predictor 102 that performs intra prediction. Whether to perform inter prediction or intra prediction for a prediction unit may be determined, and specific information (e.g., an intra prediction mode, a motion vector, a reference picture, etc.) according to each prediction method may be determined. In this case, a processing unit where prediction is performed and a processing unit where a prediction method and specific details are determined may be different. For example, a prediction method, a prediction mode, etc. may be determined in a prediction unit, and prediction may be performed in a transform unit.

A residual value (a residual block) between a generated prediction block and an original block may be input to a transformer 105. In addition, prediction mode information, motion vector information, etc. used for prediction may be encoded in an entropy encoder 107 with a residual value and transmitted to a decoder. When a specific encoding mode is used, it is also possible to encode an original block as it is and transmit it to a decoder without generating a prediction block through predictors 102 and 103.

An intra predictor 102 may generate a prediction block based on reference pixel information around a current block, which is pixel information within a current picture. When the prediction mode of a neighboring block of a current block where intra prediction will be performed is inter prediction, a reference pixel included in a neighboring block to which inter prediction is applied may be replaced with a reference pixel within another neighboring block to which intra prediction is applied. In other words, when a reference pixel is not available, unavailable reference pixel information may be used by being replaced with at least one of the available reference pixels.

In intra prediction, a prediction mode may have a directional prediction mode that uses reference pixel information according to a prediction direction and a non-directional mode that does not use directional information when performing prediction. A mode for predicting luma information and a mode for predicting chroma information may be different, and intra prediction mode information used for predicting luma information or predicted luma signal information may be utilized to predict chroma information.

An intra predictor 102 may include an Adaptive Intra Smoothing (AIS) filter, a reference pixel interpolator and a DC filter. An AIS filter is a filter that performs filtering on the reference pixel of a current block, and may adaptively determine whether to apply a filter depending on a prediction mode in a current prediction unit. When the prediction mode of a current block is a mode that does not perform AIS filtering, an AIS filter may not be applied.

The reference pixel interpolator of an intra predictor 102 may interpolate a reference pixel to generate a reference pixel at a fractional unit position when an intra prediction mode in a prediction unit is a prediction unit that performs intra prediction based on a pixel value interpolating a reference pixel. When a prediction mode in a current prediction unit is a prediction mode that generates a prediction block without interpolating a reference pixel, a reference pixel may not be interpolated. A DC filter may generate a prediction block through filtering when the prediction mode of a current block is a DC mode.

An inter predictor 103 generates a prediction block by using motion information and a pre-reconstructed reference image stored in a memory 112. Motion information may include, for example, a motion vector, a reference picture index, a list 1 prediction flag, a list 0 prediction flag, etc.

A residual block including residual value information, which is a difference value between a prediction unit generated in predictors 102 and 103 and an original block in a prediction unit, may be generated. A generated residual block may be input to a transformer 130 and transformed.

An inter predictor 103 may derive a prediction block based on information of at least one of a previous picture or a subsequent picture of a current picture. In addition, based on information of some regions where encoding is completed within a current picture, the prediction block of a current block may be derived. An inter predictor 103 according to an embodiment of the present invention may include a reference picture interpolator, a motion predictor and a motion compensator.

A reference picture interpolator may receive reference picture information from a memory 112 and generate pixel information less than or equal to an integer pixel from a reference picture. For a luma pixel, a DCT-based 8-tap interpolation filter with a different filter coefficient may be used to generate pixel information less than or equal to an integer pixel in a ¼ pixel unit. For a chroma signal, a DCT-based 4-tap interpolation filter with a different filter coefficient may be used to generate pixel information less than or equal to an integer pixel in a ⅛ pixel unit.

A motion predictor may perform motion prediction based on a reference picture interpolated by a reference picture interpolator. Various methods such as FBMA (Full search-based Block Matching Algorithm), TSS (Three Step Search), NTS (New Three-Step Search Algorithm), etc. may be used as a method for calculating a motion vector. A motion vector may have a motion vector value in a ½ or ¼ pixel unit based on an interpolated pixel. A motion predictor may predict the prediction block of a current block by changing a motion prediction method. Various methods such as a skip method, a merge method, an AMVP (Advanced Motion Vector Prediction) method, etc. may be used as a motion prediction method.

A subtractor 104 subtracts a block to be currently encoded and a prediction block generated in an intra predictor 102 or an inter predictor 103 to generate the residual block of a current block.

A transformer 105 may transform a residual block including residual data by using a transform method such as DCT, DST, KLT (Karhunen Loeve Transform, KL), SVD, etc. In this case, a transform method (or a transform kernel) may be determined based on an intra prediction mode in a prediction unit used to generate a residual block. For example, according to an intra prediction mode, DCT may be used in a horizontal direction and DST may be used in a vertical direction.

A quantizer 106 may quantize values transformed into a frequency domain in a transformer 105. A quantization coefficient may vary depending on a block or the importance of an image. A value calculated in a quantizer 106 may be provided to a dequantizer 108 and an entropy encoder 107.

The transformer 105 and/or quantizer 106 may be selectively included in an image encoding device 100. In other words, an image encoding device 100 may encode a residual block by performing at least one of transform or quantization on the residual data of a residual block or skipping both transform and quantization. Even when any one of transform or quantization is not performed or both transform and quantization are not performed in an image encoding device 100, a block entered as an input of an entropy encoder 107 is typically referred to as a transform block. An entropy encoder 107 entropy encodes input data. Entropy encoding may use various encoding methods such as Exponential Golomb, CAVLC (Context-Adaptive Variable Length Coding), CABAC (Context-Adaptive Binary Arithmetic Coding), etc.

An entropy encoder 107 may encode a variety of information such as coefficient information of a transform block, block type information, prediction mode information, partition unit information, prediction unit information, transmission unit information, motion vector information, reference frame information, block interpolation information, filtering information, etc. Coefficients of a transform block may be encoded in a sub-block unit within a transform block.

In order to encode the coefficient of a transform block, various syntax elements such as Last_sig, a syntax element showing the position of a first non-zero coefficient according to scan order, Coded_sub_blk_flag, a flag showing whether there is at least one non-zero coefficient in a sub-block, Sig_coeff_flag, a flag showing whether a coefficient is non-zero, Abs_greaterN_flag, a flag showing whether the absolute value of a coefficient is greater than N (here, N may be a natural number such as 1, 2, 3, 4, 5, etc.) and Sign_flag, a flag showing the sign of a coefficient may be encoded. The residual value of a coefficient that is not encoded by the syntax elements alone may be encoded through a syntax element remaining_coeff.

A dequantizer 108 and an inverse transformer 109 dequantize values quantized in a quantizer 106 and inversely transform values transformed in a transformer 105. A residual value generated in a dequantizer 108 and an inverse transformer 109 may be combined with a prediction unit predicted through a motion estimator, a motion compensator and an intra predictor 102 included in predictors 102 and 103 to generate a reconstructed block. An adder 110 adds a prediction block generated in predictors 102 and 103 and a residual block generated through an inverse transformer 109 to generate a reconstructed block.

A filter 111 may include at least one of a deblocking filter, an offset correction unit and an ALF (Adaptive Loop Filter).

A deblocking filter may remove block distortion generated by a boundary between blocks in a reconstructed picture. In order to determine whether to perform deblocking, whether to apply a deblocking filter to a current block may be determined based on a pixel included in several columns or rows included in a block. When a deblocking filter is applied to a block, a strong filter or a weak filter may be applied depending on required deblocking filtering strength. In addition, in applying a deblocking filter, horizontal filtering and vertical filtering may be processed in parallel when performing vertical filtering and horizontal filtering.

An offset correction unit may correct an offset with an original image in a pixel unit for an image where deblocking is performed. In order to perform offset correction for a specific picture, a method for dividing a pixel included in an image into a certain number of regions, determining a region where an offset will be performed and applying an offset to a corresponding region or a method for applying an offset by considering edge information of each pixel may be used.

ALF (Adaptive Loop Filtering) may be performed based on a value obtained by comparing a filtered reconstructed image with an original image. After dividing a pixel included in an image into a predetermined group, one filter which will be applied to a corresponding group may be determined to perform filtering differentially for each group. Information related to whether to apply ALF may be transmitted by coding unit (CU) of a luma signal, and the shape and filter coefficient of an ALF filter which will be applied may be different for each block. In addition, an ALF filter in the same form (a fixed form) may be applied regardless of the characteristic of a block to be applied.

A memory 112 may store a reconstructed block or picture calculated through a filter 111, and a stored reconstructed block or picture may be provided to predictors 102 and 103 when performing inter prediction.

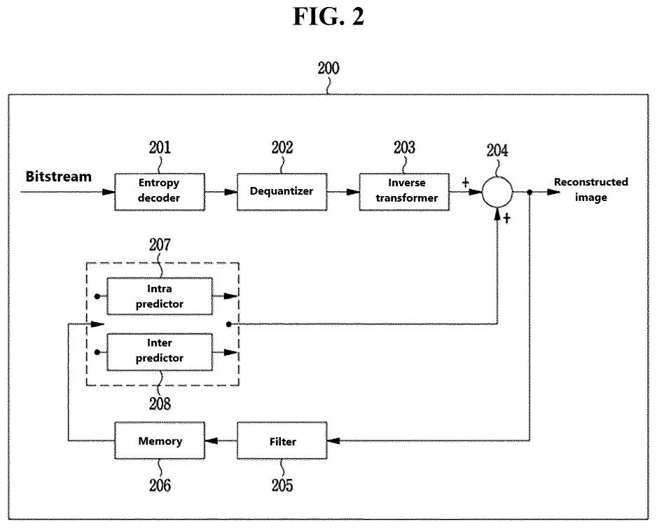

Next, an image decoding device according to an embodiment of the present invention will be described by referring to a drawing. FIG. 2 is a block diagram showing an image decoding device 200 according to an embodiment of the present invention.

Referring to FIG. 2, an image decoding device 200 may include an entropy decoder 201, a dequantizer 202, an inverse transformer 203, an adder 204, a filter 205, a memory 206 and predictors 207 and 208.

When an image bitstream generated by an image encoding device 100 is input to an image decoding device 200, an input bitstream may be decoded according to a process opposite to a process performed in an image encoding device 100.

An entropy decoder 201 may perform entropy decoding in a process opposite to a process where entropy encoding is performed in the entropy encoder 107 of an image encoding device 100. For example, various methods such as Exponential Golomb, CAVLC (Context-Adaptive Variable Length Coding) and CABAC (Context-Adaptive Binary Arithmetic Coding) may be applied in response to a method performed in an image encoder. An entropy decoder 201 may decode syntax elements described above, i.e., Last_sig, Coded_sub_blk_flag, Sig_coeff_flag, Abs_greaterN_flag, Sign_flag, and remaining_coeff. In addition, an entropy decoder 201 may decode information related to intra prediction and inter prediction performed in an image encoding device 100.

A dequantizer 202 performs dequantization on a quantized transform block to generate a transform block. It operates in substantially the same manner as a dequantizer 108 in FIG. 1.

An inverse transformer 203 performs inverse transform on a transform block to generate a residual block. In this case, a transform method may be determined based on information about a prediction method (inter or intra prediction), the size and/or shape of a block, an intra prediction mode, etc. It operates in substantially the same manner as an inverse transformer 109 in FIG. 1.

An adder 204 adds a prediction block generated in an intra predictor 207 or an inter predictor 208 and a residual block generated through an inverse transformer 203 to generate a reconstructed block. It operates in substantially the same manner as an adder 110 in FIG. 1.

A filter 205 reduces various types of noise occurring in reconstructed blocks.

A filter 205 may include a deblocking filter, an offset correction unit and a ALF.

Information on whether a deblocking filter was applied to a corresponding block or picture and when a deblocking filter was applied, information on whether a strong filter or a weak filter was applied may be provided from an image encoding device 100. The deblocking filter of an image decoding device 200 may receive deblocking filter-related information provided from an image encoding device 100 and perform deblocking filtering on a corresponding block in an image decoding device 200.

An offset correction unit may perform offset correction on a reconstructed image based on the type of offset correction applied to an image during encoding, offset value information, etc.

ALF may be applied to a coding unit based on information on whether to apply ALF, ALF coefficient information, etc. provided from an image encoding device 100. This ALF information may be included in a specific parameter set and provided. A filter 205 operates in substantially the same manner as a filter 111 in FIG. 1.

A memory 206 stores a reconstructed block generated by an adder 204. It operates in substantially the same manner as a memory 112 in FIG. 1.

Predictors 207 and 208 may generate a prediction block based on prediction block generation-related information provided from an entropy decoder 201 and pre-decoded block or picture information provided from a memory 206.

Predictors 207 and 208 may include an intra predictor 207 and an inter predictor 208. Although not shown separately, predictors 207 and 208 may further include a prediction unit determination unit. A prediction unit determination unit may receive a variety of information such as prediction unit information input from an entropy decoder 201, prediction mode information of an intra prediction method, motion prediction-related information of an inter prediction method, etc. to distinguish a prediction unit from a current encoding unit, and determine whether a prediction unit performs inter prediction or intra prediction. An inter predictor 208 may perform inter prediction for a current prediction unit based on information included in at least one picture of a previous picture or a subsequent picture of a current picture including a current prediction unit by using information necessary for inter prediction in a current prediction unit provided from an image encoder 100. Alternatively, inter prediction may be performed based on information of a pre-reconstructed partial region within a current picture including a current prediction unit.

In order to perform inter prediction, whether a motion prediction method in a prediction unit included in a corresponding encoding unit is a Skip Mode, a Merge Mode or an AMVP Mode may be determined based on an encoding unit.

An intra predictor 207 generates a prediction block by using pixels which are positioned around a block to be currently encoded and previously reconstructed.

An intra predictor 207 may include an Adaptive Intra Smoothing (AIS) filter, a reference pixel interpolator and a DC filter. An AIS filter is a filter that performs filtering on the reference pixel of a current block, and may adaptively determine whether to apply a filter depending on a prediction mode in a current prediction unit. AIS filtering may be performed on the reference pixel of a current block by using AIS filter information and a prediction mode in a prediction unit provided from an image encoding device 100. When the prediction mode of a current block is a mode that does not perform AIS filtering, an AIS filter may not be applied.

The reference pixel interpolator of an intra predictor 207 may interpolate a reference pixel to generate a reference pixel at a fractional unit position when a prediction mode in a prediction unit is a prediction unit that performs intra prediction based on a pixel value interpolating a reference pixel. A generated reference pixel at a fractional unit position may be used as the prediction pixel of a pixel within a current block. When a prediction mode in a current prediction unit is a prediction mode that generates a prediction block without interpolating a reference pixel, a reference pixel may not be interpolated. A DC filter may generate a prediction block through filtering when the prediction mode of a current block is a DC mode.

An intra predictor 207 operates in substantially the same manner as an intra predictor 102 in FIG. 1.

An inter predictor 208 generates an inter prediction block by using a reference picture and motion information stored in a memory 206. An inter predictor 208 operates in substantially the same manner as an inter predictor 103 in FIG. 1.

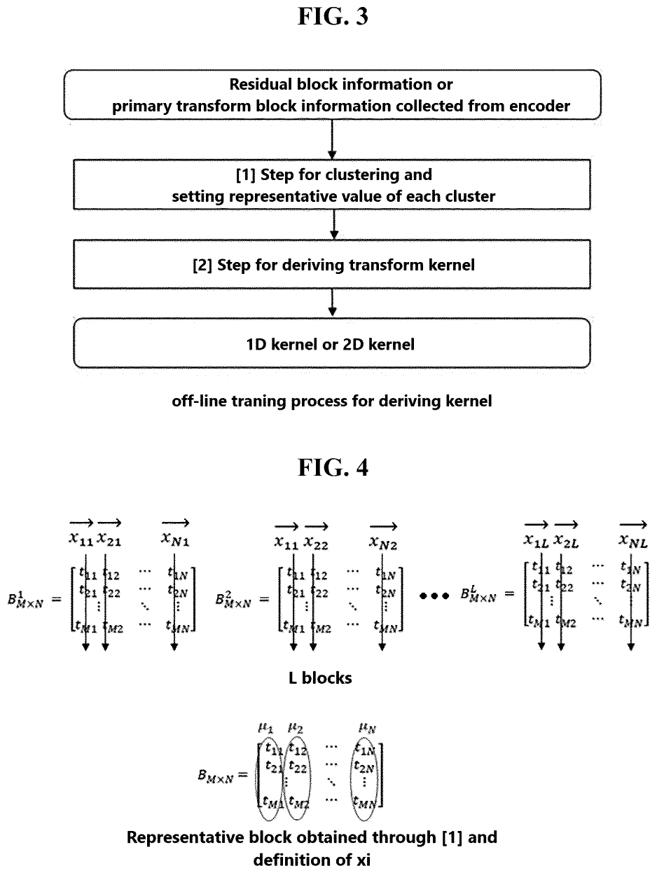

FIG. 3 is a diagram showing an off-line training process for deriving a transform kernel.

A method for deriving a transform kernel may be described in FIG. 3. First, in order to derive clustering and the representative value of each cluster, information extracted from an encoding process may be used. Here, the information may include a residual block, a primary transform block, etc. The information may be used as input information in a step for deriving a transform kernel. As an example, when deriving a primary transform kernel, a residual block may be used as input information for offline training. When deriving a secondary transform kernel, a primary transform block may be used as input information for offline training.

In addition, in order to quickly obtain training data, a primary transform kernel may be derived by using a residual block directly reconstructed in a decoder, and a secondary transform kernel may be derived by using a reconstructed primary transform block.

Hereinafter, each step for deriving a transform kernel in FIG. 3 is specifically described.

### [1] A Step for Clustering and Setting the Representative Value of Each Cluster

A plurality of blocks may be clustered by using a K-means algorithm (or an Isodata algorithm), etc., and the representative value of each cluster may be set.

For primary transform, residual blocks in a M×N (M: height, N: width) size may be used. For secondary transform, primary-transformed blocks in a M×N (M: height, N: width) size may be used.

In this case, both primary/secondary transform may set the number of clusters and the number of representative values as any K. Here, K may be an integer such as 1, 2, 3, 4, etc.

All or part of the K representative values may be used to derive a transform kernel. As an example, x of the K representative values may be selected and used to derive a transform kernel. Here, x may be a natural number smaller than K.

As an embodiment, when obtaining the representative value of 30,000 4×4 block-sized residual blocks, K may be set as 3. Since K is set as 3, a total of 3 representative values may be obtained. In this case, 2 of the 3 representative values may be selected and used to derive a transform kernel. Accordingly, 2 transform kernels may be derived in [2] A step for deriving a transform kernel through 2 representative values.

### [2] A Step for Deriving a Transform Kernel

A KL or SVD transform kernel is derived by using a covariance matrix or a correlation matrix of blocks clustered through ‘[1] A step for clustering and setting the representative value of each cluster’. In this case, the size of a block for deriving a kernel may be M×N (M×N may use a matrix notation).

### [2]-A. A Method for Deriving a 2D KL Transform Kernel Through a Covariance Matrix

First, Eigen value λ for Cov(MN×MN, may be derived.

(for reference, when a SVD transform kernel is derived, correlation Cor_{(MN×MN)}=μμ instead of covariance may be used.)

First, as a condition for deriving Eigen value λ, |Cov MN×MN^{-λ}|⁼⁰, and λ may have a range from λ₁ to λ_{MN}. λ₁>λ₂> . . . >λ_{MN} may show the order of high energy.

A covariance matrix may be derived by Equation 1 below.

$${Cov}_{MN \times MN} = \frac{1}{L} ( {x}_{i - μ} ) {( {x}_{i - μ} )}^{T} \qquad [ Equation 1 ]$$

Here, may represent a clustered block in a MN×1 vector form. In addition, u may represent a MN×1 average vector for L sample data.

Afterwards, orthonormal φ, vectors (φMN×MN) according to the value of λᵢ may be calculated (i=1, 2, 3, . . . , MN). Afterwards, it may be used to derive

$${ϕ}_{MN \times MN}^{T}$$

(KL Transform kernel) as in Equation 2.

$${ϕ}_{MN \times MN}^{T}$$

may refer to the transposition of φMN×MN. MN refers to M×N. As an example, if M=4 and N=8, MN may be 32. Equation 2 may show definition for φMN×MN in an equation.

$${ϕ}_{MN \times MN} = ( {ϕ}_{1} {ϕ}_{2} ... {ϕ}_{MN} ) = ( \begin{matrix}{ϕ}_{11} & {ϕ}_{21} & ⋯ & {ϕ}_{MN , 1} \\ {ϕ}_{12} & {ϕ}_{22} & ⋯ & {ϕ}_{MN , 2} \\ ⋯ & ⋯ & ⋯ & ⋯ \\ {ϕ}_{1 , MN} & {ϕ}_{2 , MN} & ⋯ & {ϕ}_{MN , MN}\end{matrix} ) \qquad [ Equation 2 ]$$

### [2]-B. A Method for Deriving a 1D KL Transform Kernel (Through a Vertical Covariance Matrix and Horizontal Covariance Matrix)

### [a Method for Deriving a 1D KL Transform Kernel by Using a Vertical Covariance Matrix]

In order to derive a vertical kernel, Eigen value λ for VCov_{(M×N)} may be derived.

(for reference, when a SVD transform kernel is derived, correlation

$$V {Cor}_{M \times M} = \frac{1}{N} {\sum }_{i = 1}^{N} ( {μ}_{i} ) {( {μ}_{i} )}^{T}$$

instead of covariance may be used.)

First, as a condition for deriving Eigen value λ, |VCov_{M×M}−λI|=0, and λ may have a range from λ₁ to λ_{M}. λ₁>λ₂> . . . >λ_{M} may show the order of high energy.

After calculating orthonormal φ, vectors according to the value of λ₁,

$${ϕ}_{M \times M}^{T}$$

(Vertical KL Transform kernel) may be derived as in Equation 3.

$${ϕ}_{M \times M}^{T}$$

may be the transposition of φM×M.

A Vertical Covariance Matrix may be derived by Equation 3 below.

$$V {Cov}_{M \times M} = \frac{1}{N} {\sum }_{i = 1}^{N} ( {y}_{i} ) {( {y}_{i} )}^{T} \qquad [ Equation 3 ]$$

Here,

$${y}_{i} = \frac{1}{L} {\sum }_{j = 1}^{N} ( {x}_{ij} - {μ}_{i} ) ,$$

i may be 1,2,3, . . . , N, xᵢ, may be a MX1 vector, i may be a column, j may be a sample block number, and μ, may be the MX1 average vector of the i-th column of xᵢ.

Here, xᵢ, and μ, obtained through ‘[1] A step for clustering and setting the representative value of each cluster’ are shown in FIG. 4.

Afterwards, it may be used to derive φM×N. (Vertical KL Transform kernel) as in Equation 4. Equation 4 may show definition for φM×M in an equation.

$${ϕ}_{M \times M} = ( {ϕ}_{1} {ϕ}_{2} ... {0}_{M} ) = ( \begin{matrix}{ϕ}_{11} & {0}_{21} & ⋯ & {ϕ}_{M , 1} \\ {ϕ}_{12} & {0}_{22} & ⋯ & {0}_{M , 2} \\ ⋯ & ⋯ & ⋯ & ⋯ \\ {0}_{1 , M} & {ϕ}_{2 , M} & ⋯ & {ϕ}_{M , M}\end{matrix} ) \qquad [ Equation 4 ]$$

### [A Method for Deriving a 1D KL Transform Kernel by Using a Horizontal Covariance Matrix]

In order to derive a horizontal kernel, Eigen value λ for HCov_{N×M} may be derived.

(for reference, when a SVD transform kernel is derived, correlation

$$V {Cor}_{N \times N} = \frac{1}{M} {\sum }_{i = 1}^{M} ( {μ}_{i} ) {( {μ}_{i} )}^{T}$$

instead of covariance may be used.)

First, as a condition for deriving Eigen value λ, |HCov_{N×N}−λI|M=0, and λ may have a range from λ₁ to λ_{N}. λ₁>λ₂> . . . >λ_{N} may show the order of high energy.

After calculating orthonormal φ, vectors according to the value of λ₁,

$${ϕ}_{N \times N}^{T}$$

(Horizontal KL Transform kernel) may be derived as in Equation 5.

$${ϕ}_{N \times N}^{T}$$

may be the transposition of φN×N.

$$H {Cov}_{N \times N} = \frac{1}{M} {\sum }_{i = 1}^{M} ( {y}_{i} ) {( {y}_{i} )}^{T} \qquad [ Equation 5 ]$$

Here,

$${y}_{i} = \frac{1}{L} {Σ}_{j = 1}^{N} ( {x}_{ij} - {μ}_{i} ) ,$$

i may be 1, 2, 3, . . . , N, xᵢ, may be a MX1 vector, i may be a row, j may be a sample block number, and μ, may be the MX1 average vector of the i-th row of xᵢ.

Afterwards, it may be used to derive φN×N (Horizontal KL Transform kernel) as in Equation 6.

$${ϕ}_{N \times N} = ( {ϕ}_{1} {ϕ}_{2} {…ϕ}_{N} ) = ( \begin{matrix}{ϕ}_{11} & {ϕ}_{21} & ⋯ & {ϕ}_{N , 1} \\ {ϕ}_{12} & {ϕ}_{23} & ⋯ & {ϕ}_{N , 2} \\ ⋯ & ⋯ & ⋯ & ⋯ \\ {ϕ}_{1 , N} & {ϕ}_{2 , N} & ⋯ & {ϕ}_{N , N}\end{matrix} ) \qquad [ Equation 6 ]$$

An embodiment in which a kernel derived in [2] A step for deriving a transform kernel is applied is described below. In this case, it is described mainly based on a KL transform kernel, but it may also be applied in the same way for a SVD transform kernel.

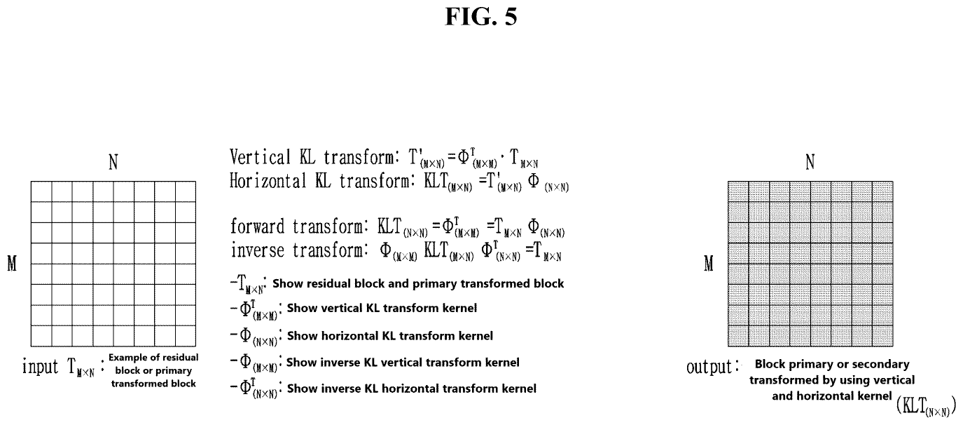

FIG. 5 shows an embodiment in which a 1D (1 dimension) transform kernel is applied.

An embodiment in FIG. 5 is an example in which a 1D transform kernel (separable KLT) is applied, and describes an example in which a 1D transform kernel is applied to primary transform or secondary transform. An input value in FIG. 5 may be a residual block or a primary-transformed block, and an output value may be a block that is primary or secondary-transformed by using at least one of a vertical kernel or a horizontal kernel.

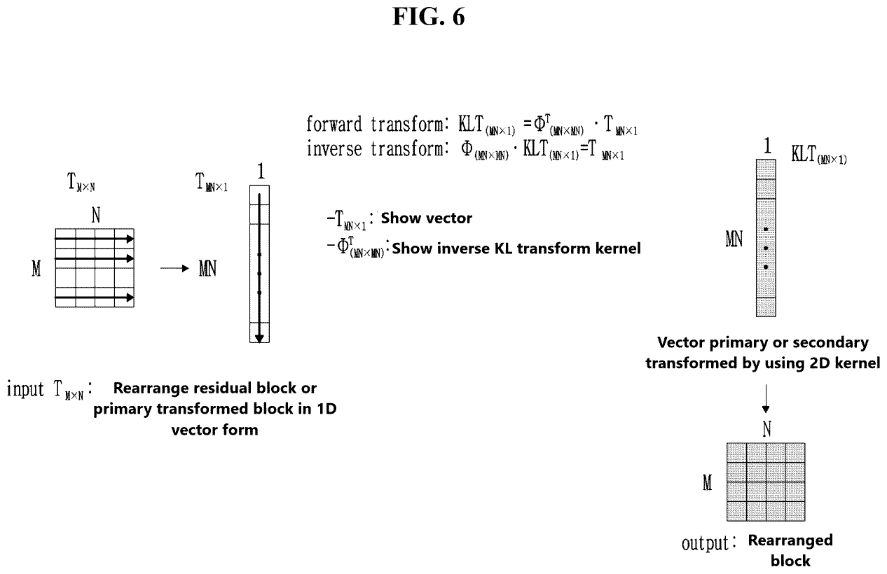

FIG. 6 shows an embodiment in which a 2D transform kernel is applied. An embodiment in FIG. 6 is an example in which a 2D transform kernel (non-separable KLT) is applied. An input value in FIG. 6 may be a residual block or a block obtained by rearranging a primary transform block in a one-dimensional vector form, and an output value may be a block obtained by rearranging a primary or secondary-transformed vector by using a 2D transform kernel.

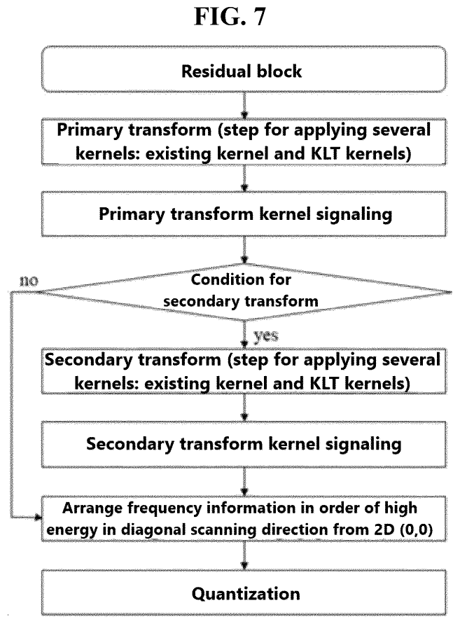

FIG. 7 is a diagram showing a transform process in an encoder.

First, first transform may be performed on a residual block to obtain a primary transform block. Whether to perform secondary transform on the primary transform block may be determined. When it is determined to perform the secondary transform, the secondary transform may be performed to obtain a secondary transform block. A quantization block obtained by quantizing the secondary transform block may be encoded in a bitstream.

A transform kernel applied to primary transform using a residual block as an input may include a kernel such as DST and DCT and may further include a kernel such as KLT. A KLT kernel may be selectively included. Whether a KLT kernel is included may be determined according to the characteristic of a residual block. Here, the characteristic of a residual block may include the width, height, size, shape, partition depth, etc. of a residual block. In contrast, information showing whether a KLT kernel is selectively included may be encoded into a bitstream.

When primary transform is applied, information showing the type of a kernel applied to primary transform may be encoded into a bitstream.

Next, secondary transform may be performed by considering a condition for secondary transform. An example of a condition for secondary transform is as follows. Secondary transform may be performed for at least one of the following conditions.
1) When a primary transform kernel is DCT 2, DCT 2 (a vertical kernel, a horizontal kernel)
2) When there are at least 4 non-zero transform coefficients after primary transform
3) When a block size is 4×4 to 16×16 or less

For any one of the conditions, a flag showing whether to apply secondary transform may be encoded.

Secondary transform may be performed by using a primary-transformed block as an input. In addition to a kernel such as DST and DCT, a KLT kernel may be applied to secondary transform. A KLT kernel may be applied selectively. Whether a KLT kernel is applied may be determined according to the characteristic of a residual block. Here, the characteristic of a residual block may include the width, height, size, shape, partition depth, etc. of a residual block. In contrast, information showing whether a KLT kernel is selectively applied may be encoded into a bitstream.

When secondary transform is applied, information showing the type of a kernel applied to secondary transform may be encoded into a bitstream.

An embodiment for encoding a primary or secondary transform kernel is as follows.
1) When an intra prediction directional mode is DC or planar, it is encoded with kernel index 1.
2) When it is horizontal mode±5, it is encoded with kernel index 2.
3) When it is vertical mode±5, it is encoded with kernel index 3.
4) When it is diagonal mode 0, it is encoded with kernel index 4.

4 index encoding examples are shown, but some of them may be omitted.

A secondary-transformed vector may arrange frequency information with high energy in the form of a block in a diagonal scanning direction from two-dimensional coordinate (0,0). In addition, the block may be an input value in a quantization step.

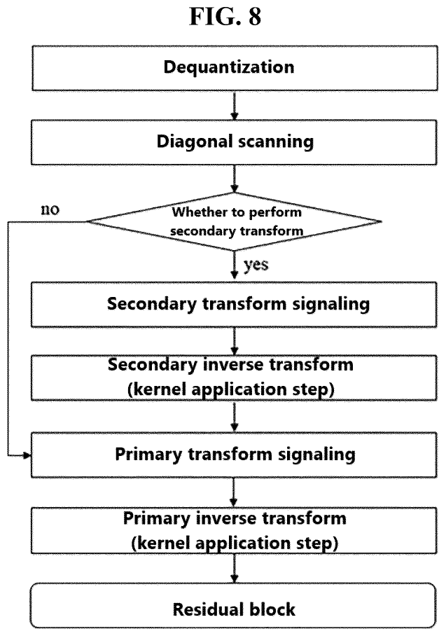

FIG. 8 is a diagram showing an inverse transform process in a decoder.

First, a quantization block obtained from a bitstream may be dequantized to obtain a secondary transform block. Whether to perform secondary inverse transform for the secondary transform block may be determined. When it is determined to perform the secondary inverse transform, the secondary inverse transform for the secondary transform block may be performed to obtain a primary transform block. It may include performing primary inverse transform for the primary transform block.

A dequantization step may be performed, and coefficients may be rearranged by diagonal scanning. When secondary inverse transform is applied, it may be rearranged in the form of a vector.

Next, whether to perform secondary inverse transform may be determined based on information about whether to apply secondary inverse transform signaled from a bitstream. In contrast, secondary inverse transform may also be performed by considering a secondary inverse transform condition. The condition may be the same as a condition considered in an encoding step.

When it is determined that secondary inverse transform is applied, a kernel which will be applied to secondary inverse transform may be determined by secondary transform kernel information signaled from a bitstream. Secondary inverse transform may be performed based on a determined secondary inverse transform kernel.

Next, primary transform kernel information for primary inverse transform may be signaled from a bitstream. A transform kernel to be applied to primary inverse transform may be determined based on the primary transform kernel information. Primary inverse transform may be performed with the determined transform kernel. A residual block may be obtained through primary inverse transform.

In a step for applying a transform kernel, input and output may be defined as follows.

For primary transform, definition of input and output
input: M×N-sized residual block (M: height, N: width) height, N: width)
output: Primary-transformed block that performed KLT from which bases with low energy (corresponding to small λ values) were removed (a size varies depending on dimension reduction)

For primary inverse transform, definition of input and output
input: Primary-transformed block (a size varies depending on dimension reduction)
output: M×N-sized residual block

For secondary transform, definition of input and output
input: P×Q primary-transformed block (P≤M, Q≤N)
output: Secondary-transformed block that performed KLT from which bases with low energy (corresponding to small λ values) were removed (a size varies depending on dimension reduction)

For secondary inverse transform, definition of input and output
input: Secondary-transformed block
output: P x Q primary-transformed block

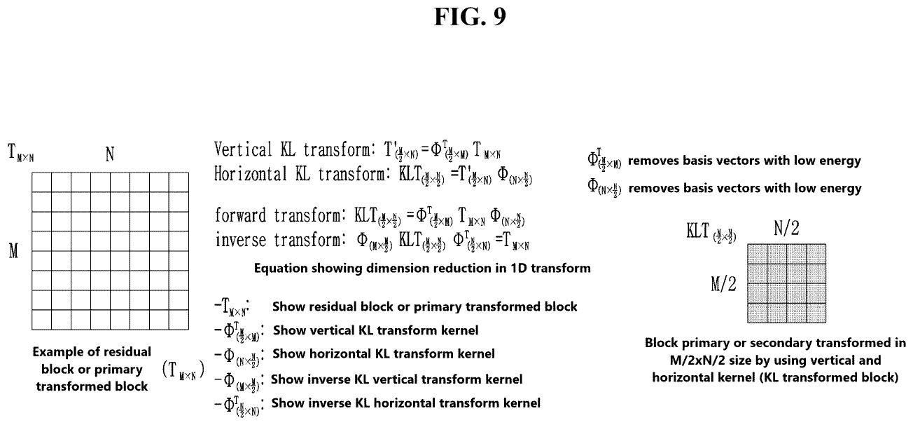

FIG. 9 is a diagram showing a first embodiment in which a 1D transform kernel is applied by utilizing dimension reduction.

A first embodiment in FIG. 9 is an example in which a 1D transform kernel (separable KLT) is applied, and may be an example in which a 1D transform kernel is applied to primary transform or secondary transform. As dimension reduction is performed in an embodiment of FIG. 9, when an input block is M×N, the size of an output block may be M/2×N/2, unlike FIG. 5 (for FIG. 5, an output block is M×N). Specifically, it shows an example in which a vertical KL transform kernel and a horizontal KL transform kernel are used, and dimension reduction of ½ is shown in vertical and horizontal directions, respectively.

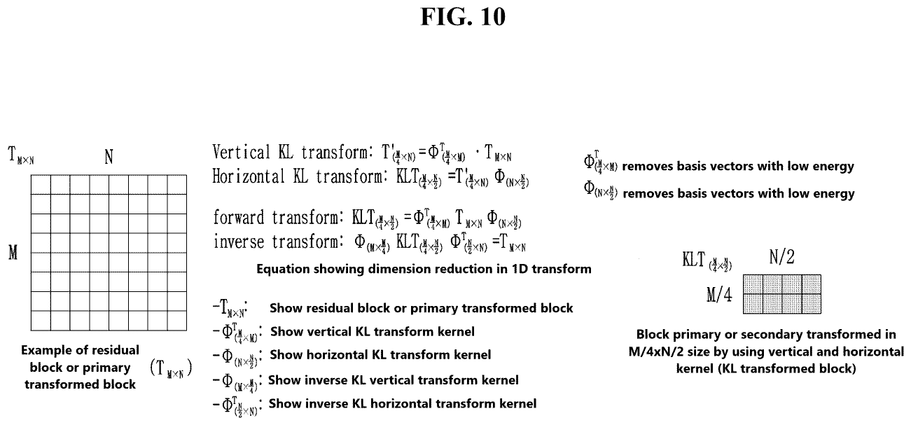

FIG. 10 is a diagram showing a second embodiment in which a 1D transform kernel is applied by utilizing dimension reduction.

A second embodiment in FIG. 10 is an example in which a 1D transform kernel (separable KLT) is applied, and may apply a 1D transform kernel to primary transform or secondary transform. As dimension reduction is performed in an embodiment of FIG. 10, when an input block is M×N, the size of an output block may be M/4×N/2. Specifically, a vertical KL transform kernel and a horizontal KL transform kernel are used, and dimension reduction of 14 may be shown in a vertical direction and dimension reduction of ½ may be shown in a horizontal direction.

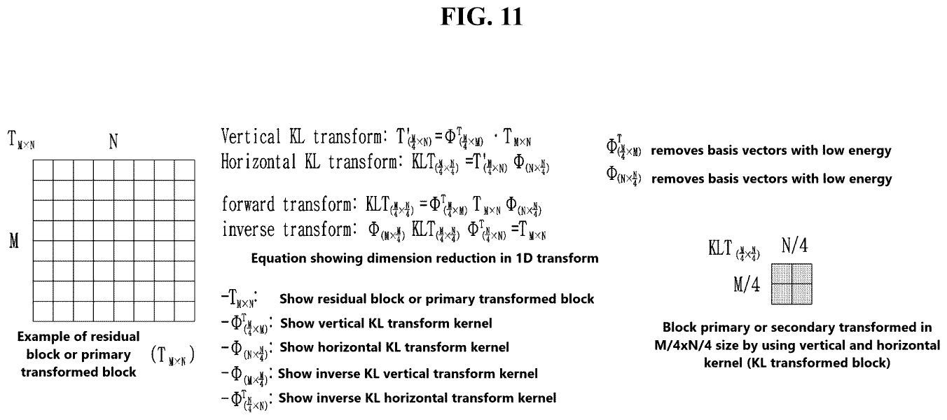

FIG. 11 is a diagram showing a third embodiment in which a 1D transform kernel is applied by utilizing dimension reduction.

A third embodiment in FIG. 11 is an example in which a 1D transform kernel (separable KLT) is applied, and may apply a 1D kernel to primary transform or secondary transform. As dimension reduction is performed in an embodiment of FIG. 11, when an input block is M×N, the size of an output block may be M/4×N/4. Specifically, a vertical KL transform kernel and a horizontal KL transform kernel are used, and dimension reduction of 14 may be shown in vertical and horizontal directions, respectively.

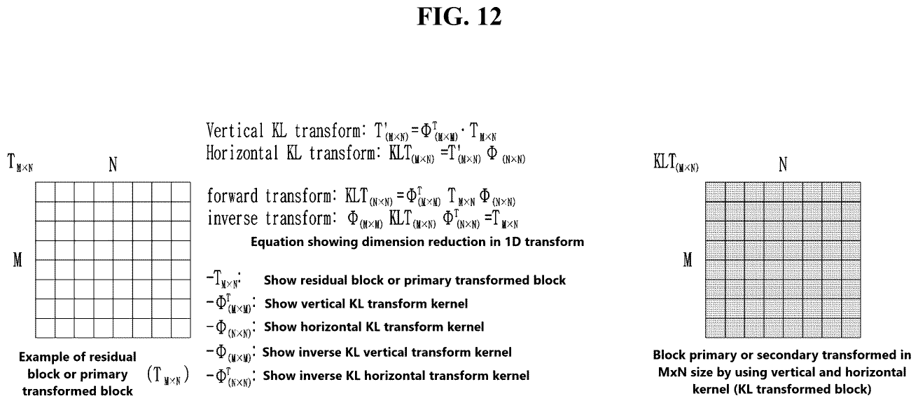

FIG. 12 is a diagram showing a fourth embodiment in which a 1D transform kernel is applied when the entire data is transformed without dimension reduction.

A fourth embodiment in FIG. 12 is an example in which a 1D transform kernel (separable KLT) is applied, and may apply a 1D kernel to primary transform or secondary transform. As the entire data is transformed without dimension reduction in an embodiment of FIG. 11, both the size of an input block and the size of an output block may be M×N. Specifically, it may be shown that a vertical KL transform kernel and a horizontal KL transform kernel are used without utilizing dimension reduction.

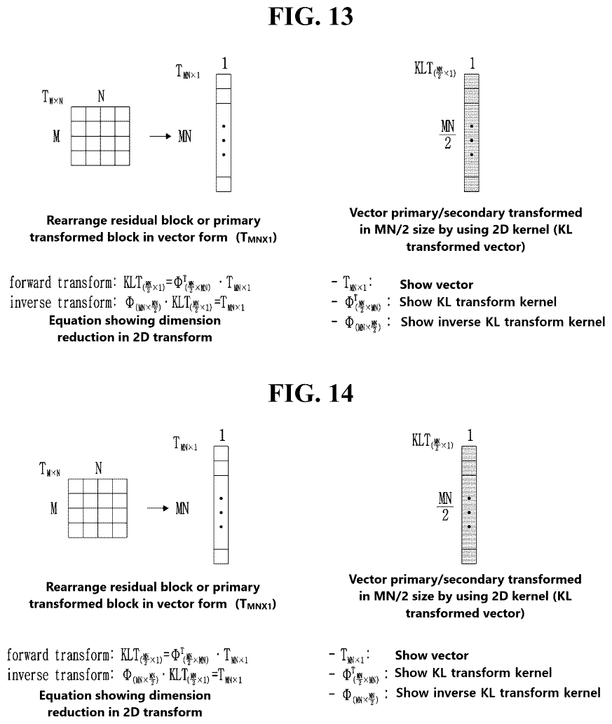

FIG. 13 is a diagram showing a first embodiment in which a 2D transform kernel is applied by utilizing dimension reduction.

As dimension reduction is performed in a first embodiment in FIG. 13 to which a 2D transform kernal is applied, an output vector may be MN/2, not MN. Specifically, a 2D KL transform kernel is used, and dimension reduction of ½ may be shown.

FIG. 14 is a diagram showing a second embodiment in which a 2D transform kernel is applied by utilizing dimension reduction.

As dimension reduction is performed in a second embodiment to which a 2D transform kernal is applied, an output vector may be MN/4, not MN when an input block is M×N. Specifically, a 2D KL transform kernel is used, and dimension reduction of ¼ may be shown.

FIG. 15 is a diagram showing a second embodiment in which a 2D transform kernel is applied by utilizing dimension reduction.

As dimension reduction is performed in a second embodiment to which a 2D transform kernal is applied, an output vector may be MN/4, not MN when an input block is M×N. Specifically, a 2D KL transform kernel is used, and dimension reduction of ¼ may be shown.

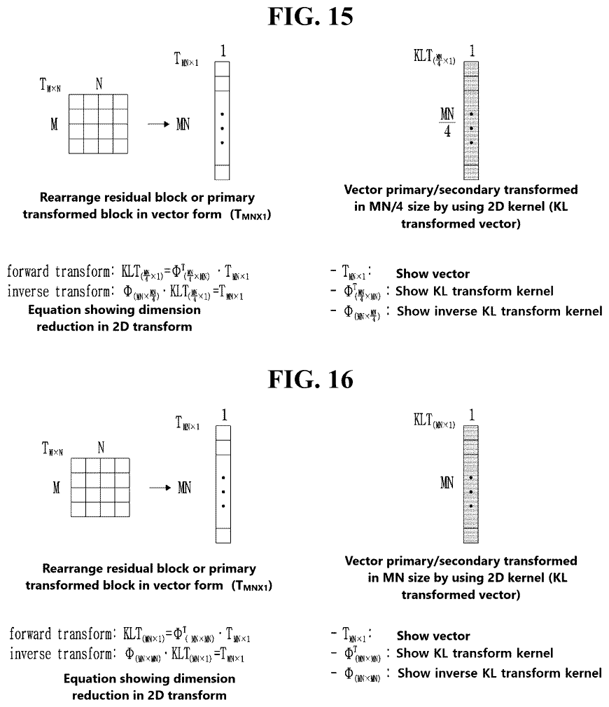

FIG. 16 is a diagram showing a third embodiment in which a 2D transform kernel is applied by utilizing dimension reduction.

As dimension reduction is not performed in a third embodiment to which a 2D transform kernal is applied, an output vector may be MN. Specifically, it may be expressed that a MN×MN-sized 2D transform kernel is applied.

Whether to utilize dimension reduction may be determined by the characteristic of a block described above or information signaled from a bitstream. This may be signaled in the higher unit of a block as well as a block unit.

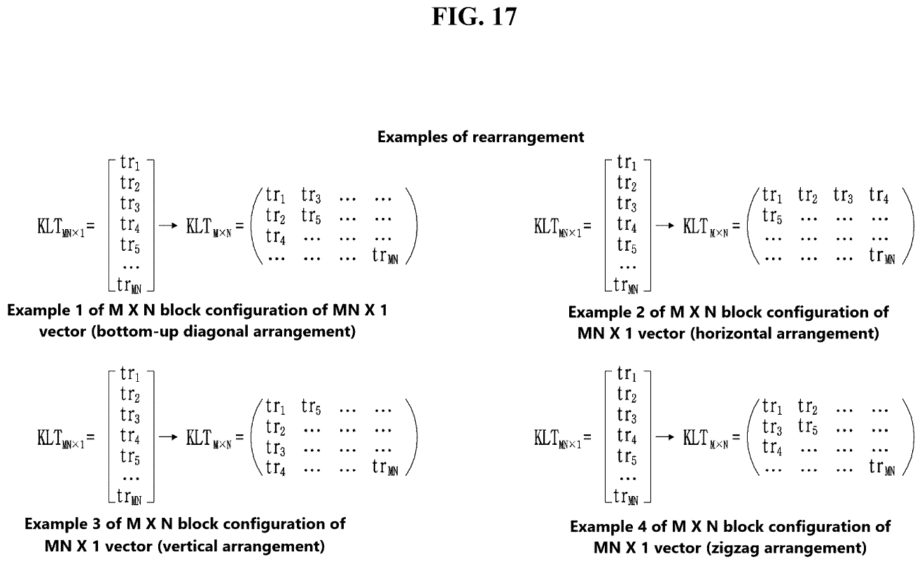

FIG. 17 shows an example in which vectors are rearranged as a 2D block.

Specifically, it shows an example in which when MN×1 vectors derived in a step for applying a transform kernel are configured into 2D M×N transform blocks, they are rearranged in 2D based on the order of high energy.

The rearrangement may include bottom-up diagonal arrangement, horizontal arrangement, zigzag arrangement, vertical arrangement, etc. According to each inclusion method, a coefficient in a vector may be rearranged into a 2D block in the order of high energy. This may be applied equally to primary or secondary transform, and may also be applied equally to SVD.

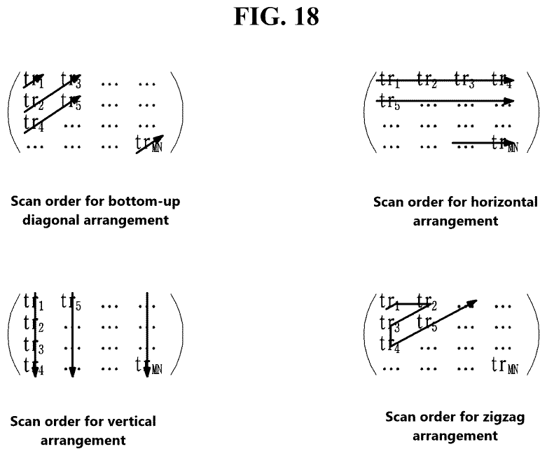

FIG. 18 shows an embodiment in which coefficients of a rearranged block are scanned.

The scan order for a quantization coefficient may vary depending on a rearrangement method in a step for applying a transform kernel. The scan order may include scan order for a bottom-up diagonal arrangement, scan order for a horizontal arrangement, scan order for a zigzag arrangement and scan order for a vertical arrangement. Information about determined scan order or information about rearrangement may be encoded/decoded through a bitstream. When scan order is determined by information about rearrangement, a rearrangement method and scan order may be in a 1:1 relationship.

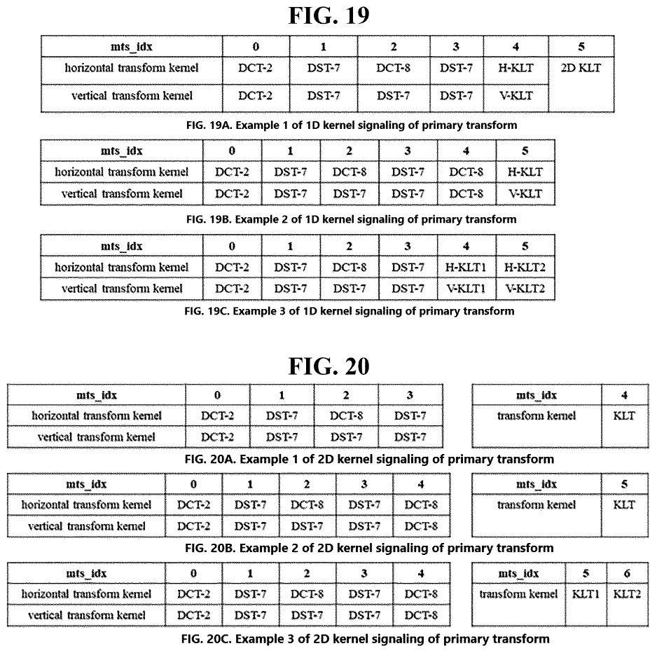

FIG. 19 is a diagram showing an embodiment in which a 1D transform kernel for primary transform is signaled.

First, H-KLT and V-KLT may refer to a Horizontal KL/SVD Transform kernel and a Vertical KL/SVD Transform kernel derived in the present invention, respectively. For primary transform, a transform kernel is signaled through mts_idx.

When a proposed 1D transform kernel is applied to primary transform, mts_idx may be defined and signaled as in an example of FIG. 19A, FIG. 19B and FIG. 19C.

The maximum value of mts_idx may be increased according to the number of kernels to be derived and applied or may be signaled by replacing DCT and DST kernel pairs. An example such as DCT-2 and V-KLT may also be possible.

FIG. 20 is a diagram showing an embodiment in which a 2D transform kernel for primary transform is signaled.

When a proposed 2D transform kernel is applied to primary transform, mts_idx may be defined and signaled as in FIG. 20A, FIG. 20B and FIG. 20C.

The maximum value of mts_idx may be increased according to the number of kernels to be derived and applied or may be signaled by replacing a DCT and DST kernel pair. KLT may refer to a KL/SVD Transform kernel derived in the present invention. As an example, for FIG. 20A, the maximum value of mts_idx may be 4, but for FIG. 20B, the maximum value of mts_idx may be 5.

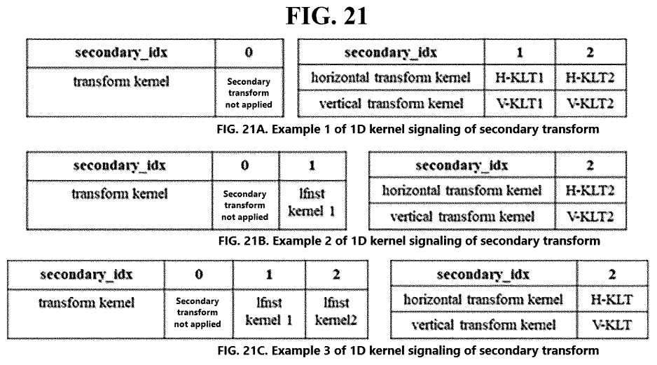

FIG. 21 is a diagram showing an embodiment in which a 1D transform kernel for secondary transform is signaled.

For secondary transform a transform kernel may be signaled through secondary_idx.

When a proposed 1D transform kernel is applied to secondary transform, secondary_idx may be defined and signaled as in FIG. 21A, FIG. 21B and FIG. 21C.

The maximum value of secondary_idx may be increased according to the number of kernels to be derived and applied or may be signaled by replacing a secondary kernel. H-KLT and V-KLT may refer to a Horizontal KL/SVD Transform kernel and a Vertical KL/SVD Transform kernel derived in the present invention, respectively.

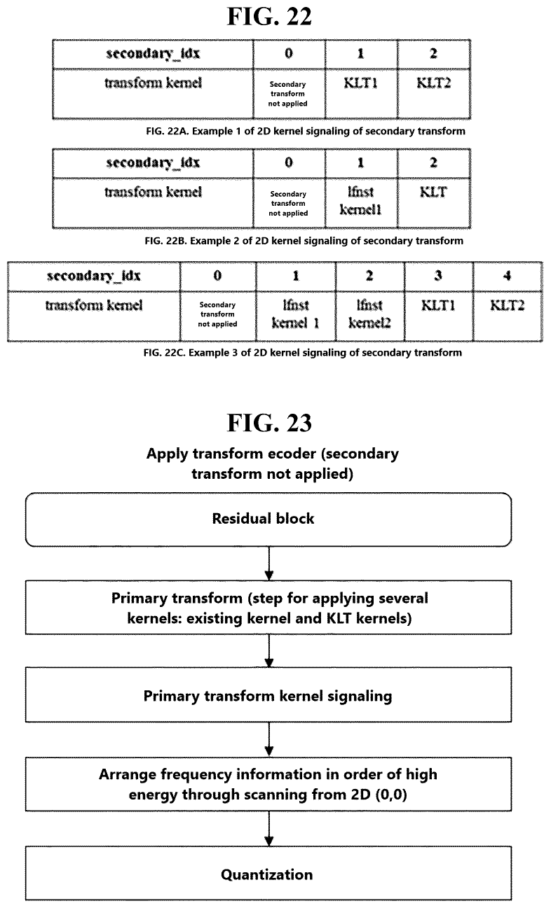

FIG. 22 is a diagram showing an embodiment in which a 2D transform kernel for secondary transform is signaled.

When a proposed 2D transform kernel is applied to secondary transform, secondary_idx may be defined and signaled as in FIG. 22A, FIG. 22B and FIG. 22C.

The maximum value of secondary_idx may be increased according to the number of kernels to be derived and applied or may be signaled by replacing a secondary kernel. KLT may refer to a KL Transform/SVD Transform kernel derived in the present invention.

FIG. 23 shows an example in which only primary transform is applied in an encoder.

The transform kernel of primary transform for a residual block may be determined. Based on the determined transform kernel of primary transform, primary transform for the residual block may be performed to obtain a primary transform block. A quantization block obtained by quantizing the primary transform block may be encoded in a bitstream.

A process of applying a transform encoder according to FIG. 23 may be a process in which a secondary transform step is omitted unlike FIG. 2. In other words, it may be a process in which only primary transform is performed. It may correspond to a case in which a condition for whether to perform secondary transform described above is No, but may also include a case in which it is omitted regardless of a condition for whether to perform secondary transform.

Whether to perform a transform process in FIG. 23 may be determined based on at least one of a prediction mode or the size of a block (or the product of the width and height of a block).

As an example, a transform process in FIG. 23 may be performed only in an intra prediction mode. In contrast, a transform process in FIG. 23 may be performed only in an inter prediction mode.

As another example, a transform process in FIG. 23 may be applied only when a block size is 4×4, 4×8, 8×4 and 8×8. As another example, a transform process in FIG. 23 may be applied only when a block size is 4×4, 4×8, 8×4, 8×8, 4×16 and 16×4.

As another example, a transform process in FIG. 23 may be applied only when the product of the width and height of a block is less than 64.

As another example, a transform process in FIG. 23 may be applied only when the prediction mode of a current block is an intra prediction mode and a block size is 4×4, 4×8, 8×4, 8×8, 4×16 and 16×4.

As another example, a transform process in FIG. 23 may be applied only when the prediction mode of a current block is an intra prediction mode and a block size is 4×4, 4×8, 8×4 and 8×8.

As another example, a transform process in FIG. 23 may be applied only when the prediction mode of a current block is an intra prediction mode the product of the width and height of a block is less than 64.

In a process of FIG. 23, the same step as in FIG. 2 may be performed in the same manner as in FIG. 2.

As an example, a step for signaling a primary transform kernel in FIG. 23 may be signaled as follows, as in FIG. 2.
1) kernel 1 when an intra prediction directional mode is DC or planar
2) kernel 2 when it is horizontal mode±5
3) kernel 3 when it is vertical mode±5
4) kernel 4 when it is diagonal mode 0

Scanning in FIG. 23 may be different in scan order for transmitting a quantized coefficient according to an arrangement method in a step for applying a transform kernel. (A result may be similar even when scanning is performed from the lowest energy.)

As an example of scanning in FIG. 23, FIG. 17 may represent scan order for a bottom-up diagonal arrangement, FIG. 18 may represent scan order for a horizontal arrangement, FIG. 19 may represent scan order for a vertical arrangement, and FIG. 20 may represent scan order for a zigzag arrangement.

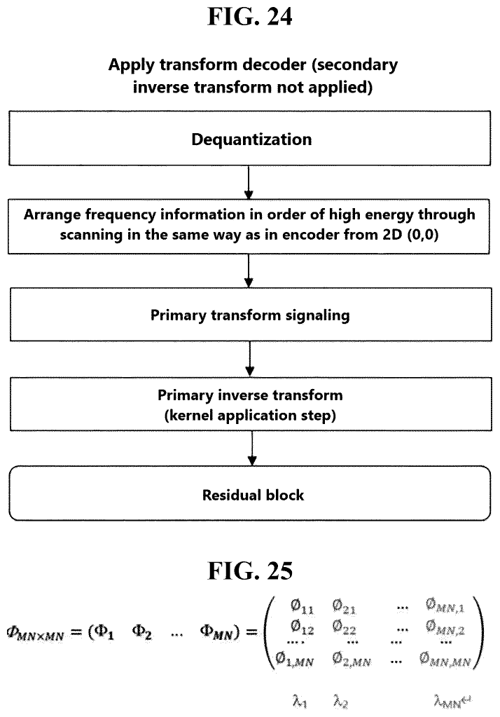

FIG. 24 shows an example in which only primary inverse transform is applied in a decoder.

A quantization block obtained from a bitstream may be dequantized to obtain a primary transform block. The transform kernel of primary inverse transform for the primary transform block may be determined. Based on the determined transform kernel of primary inverse transform, primary inverse transform for the primary transform block may be performed to obtain a residual block.

A process of applying a transform decoder according to FIG. 24 may be a process in which a secondary inverse transform step is omitted unlike FIG. 3. In other words, it may be a process in which only primary inverse transform is performed. It may correspond to a case in which a condition for whether to perform secondary transform described above is No, but may also include a case in which it is omitted regardless of a condition for whether to perform secondary transform.

Whether to perform inverse transform in FIG. 24 may be determined based on at least one of a prediction mode or the size of a block (or the product of the width and height of a block).

As an example, an inverse transform process in FIG. 24 may be performed only in an intra prediction mode. In contrast, an inverse transform process in FIG. 24 may be performed only in an inter prediction mode.

As another example, an inverse transform process in FIG. 24 may be applied only when a block size is 4×4, 4×8, 8×4 and 8×8. As another example, an inverse transform process in FIG. 24 may be applied only when a block size is 4×4, 4×8, 8×4, 8×8, 4×16 and 16×4.

As another example, an inverse transform process in FIG. 24 may be applied only when the product of the width and height of a block is less than 64.

As another example, an inverse transform process in FIG. 24 may be applied only when the prediction mode of a current block is an intra prediction mode and a block size is 4×4, 4×8, 8×4, 8×8, 4×16 and 16×4.

As another example, an inverse transform process in FIG. 24 may be applied only when the prediction mode of a current block is an intra prediction mode and a block size is 4×4, 4×8, 8×4 and 8×8.

As another example, an inverse transform process in FIG. 24 may be applied only when the prediction mode of a current block is an intra prediction mode the product of the width and height of a block is less than 64.

In a process of FIG. 24, the same step as in FIG. 3 may be performed in the same manner as in FIG. 3.

Scanning in FIG. 24 may be different in scan order for transmitting a quantized coefficient according to an arrangement method in a step for applying a transform kernel. (A result may be similar even when scanning is performed from the lowest energy.)

As an example of scanning in FIG. 24, FIG. 17 may represent scan order for a bottom-up diagonal arrangement, FIG. 18 may represent scan order for a horizontal arrangement, FIG. 19 may represent scan order for a vertical arrangement, and FIG. 20 may represent scan order for a zigzag arrangement.

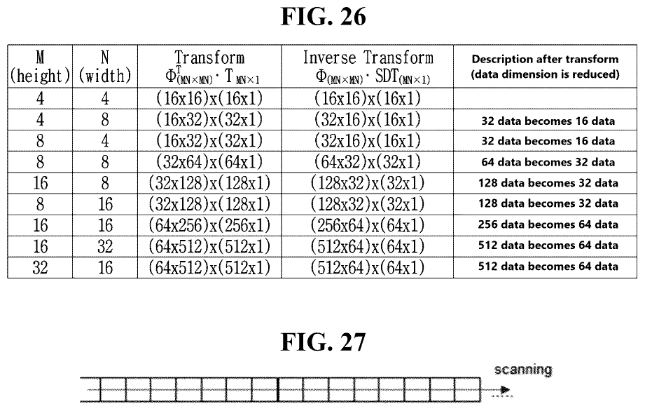

FIG. 25 is a diagram for describing an example in which only some columns of MN(=M×N) columns are used. FIG. 26 is a diagram showing a signal-dependent transform kernel size and an inverse kernel corresponding thereof.

First, referring to FIG. 25, φMN×MN may be obtained to have MN columns through the same process as in Equation 2 described above. Each column is expressed as λ and λ₁, λ₂, . . . , λ_{MN} columns may be generated. Only some of the columns may be used as a transform kernel. This considers the energy characteristic of a signal.

For reference, signal-dependent transform (SDT) for the entire data without considering energy may be expressed as Equations 7 and 8.

$${SDT}_{( MN \times 1 )} = {ϕ}_{( MN \times MN )}^{T} \times {T}_{( MN \times 1 )} \qquad [ Equation 7 ]$$

### Forward Transform

$${ϕ}_{MN \times MN} \times {SDT}_{( MN \times 1 )} = {T}_{MN \times 1} \qquad [ Equation 8 ]$$

### Inverse Transform

In contrast, signal-dependent transform may be performed by reducing the size of a transform kernel by considering only a part of the entire energy λ₁, λ₂, . . . λ_{MN}.

Referring to FIG. 26, an example may be confirmed in which the size of a transform kernel is reduced by considering only partial energy. In addition, the size of a transform kernel may be further reduced than an embodiment in FIG. 26 to further reduce the dimension of data.

As an example, since MN is 128 when M is 16 and N is 8, the size of a kernel considering the entire energy is 128×128 (lossless coding), but when up to λ₁, λ₂, . . . λ₃₂ contributing to high energy are selected and transformed by configuring

$${ϕ}_{( MN \times MN )}^{T}$$

into 32×128, 128 data are expressed as 32 data, but energy is somewhat preserved, so compression performance may be improved.

As another example, since MN is 128 when N is 8, the size of a kernel considering the entire energy is 128×128 (lossless coding), but when up λ₁, λ₂, . . . λ₁₆ contributing to high energy are selected and transformed by configuring

$${ϕ}_{( MN \times MN )}^{T}$$

into 16×128, 128 data are expressed as 16 data, but energy is somewhat preserved, so compression performance may be improved.

In order to code quantized transform coefficients that quantize transformed data, a flag showing whether there is a non-zero coefficient defined in a coefficient group unit, a flag showing whether a coefficient defined in a coefficient unit is non-zero, a flag showing whether the absolute value of a coefficient defined in a coefficient unit is greater than a specific value, information on the remaining absolute values of a coefficient defined in a coefficient unit and others may be encoded/decoded.

FIG. 27 is a diagram showing scanning of one-dimensional data.

As in FIG. 27, when applying 2D non-separable KLT or SVD, a transform result for a two-dimensional block may be one-dimensional data with the reduced dimension of data (except for 4×4). Accordingly, entropy coding (CABAC, VLC, etc.) may be performed while scanning one-dimensional data as it is after quantization as in FIG. 27.

In configuring signal-dependent transform, for intra prediction, 3˜4 transform kernels may be trained and configured according to intra mode information. In this case, an index for a specific transform kernel used for transform must also be transmitted to a decoder. Also for inter coding, 3˜4 transform kernels may be trained and configured for each residual block size after AMVP (Advanced Motion Vector Prediction) or MV (Motion Vector) Merge. In this case, an index for a specific transform kernel used for transform must also be transmitted to a decoder.

In addition, signal-dependent transform may be pre-trained and applied through the residual signal of SubBlock Partition transform and Intra sub-partition in inter prediction using the existing signal-independent transform.

A coefficient group may be used to encode/decode whether there is a coefficient through the flag of a bitstream.

When signal adaptive transform is applied, the size of a transform kernel is reduced, so for lossless coding of a video, transform must be bypassed and compressed.

After signal adaptive transform (first transform), signal adaptive transform (secondary transform) may also be performed one more time to further compress data. In this case, this proposed method is applied by arranging one-dimensional data of a primary transform coefficient two-dimensionally (in horizontal, vertical, diagonal or zigzag order) before applying secondary transform. Afterwards, a transform result for a two-dimensional block after secondary transform may be one-dimensional data with the reduced number (dimension) of data (except for 4×4). Accordingly, after quantization, entropy coding (CABAC, VLC, etc.) is performed while scanning one-dimensional data as it is.

An interpolation filter using the frequency of the present disclosure may be applied to at least one of the encoding/decoding steps. As an example, an interpolation filter may be used to interpolate a reference sample, may be used to adjust a prediction value, may be used to adjust a residual value, may be used to improve encoding/decoding efficiency after prediction is completed and may be performed as an encoding/decoding pre-processing step.

8-tap DCT-IF and 8-tap SIF using much more reference samples are applied by replacing a 4-tap Discrete Cosine Transform-based interpolation filter (DCT-IF) and a 4-tap Smoothing interpolation filer (SIF) used previously in VVC intra prediction. In some cases, a filter such as 10-tap, 12-tap, 14-tap, 16-tap, etc. may be used instead of the 8-tap filter. As an example, the characteristic of a block may be determined by using the size of a block and the frequency characteristic of a reference sample, and the type of an interpolation filter applied to the block may be selected.

8-tap DCT-IF may be obtained by Equation 9 below.

$$x ( n ) = \frac{2}{N} {Σ}_{m = 0}^{N - 1} x ( m ) {Σ}_{k = 0}^{N - 1} {C}_{k}^{2} cos \frac{( m + \frac{1}{2} ) π k}{N} cos \frac{( n + \frac{1}{2} ) π k}{N} \qquad [ Equation 9 ]$$

$${C}_{k} = \{ \begin{matrix}\frac{1}{\sqrt{2}} , k = 0 \\ 1 , otherwise\end{matrix}$$

A p/32 pixel interpolation filter (when using p=0, 1, 2, 3, . . . , 31, 1/32 fractional samples) may be obtained by replacing n=3+p/32 with a linear combination of a discrete cosine coefficient and x(m) (m=0, 1, 2, . . . , 7) in Equation 9 above.

As an example, a 8-tap DCT-IF coefficient derived for ( 0/32, 1/32, 2/32, . . . , 16/32) fractional sample positions may be obtained by using n=3+( 0/32, 1/32, 2/32, . . . , 16/32). A 8-tap DCT-IF coefficient for ( 17/32, 18/32, 19/32, . . . , 31/32) may also be obtained in the same manner as above.

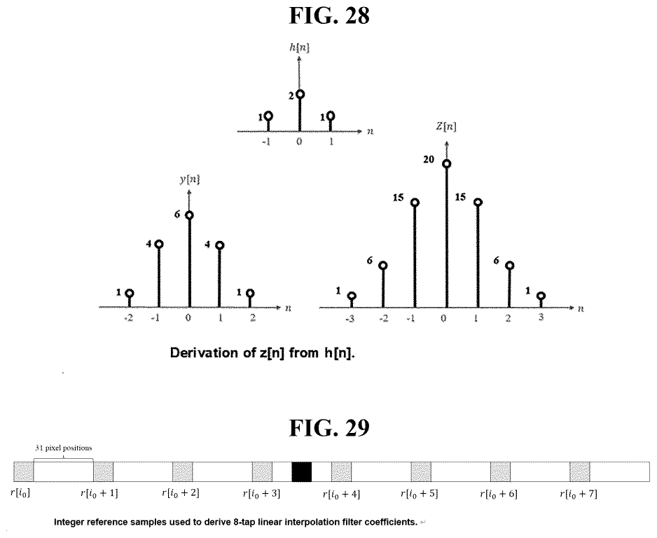

A 8-tap SIF coefficient may be obtained from the convolution of z[n] and a 1/32 fractional linear filter. Here, z[n] in FIG. 28 may be obtained from the convolution of h[n] and y[n] in Equations 10 and 11. Here, h[n] may be a 3-point [1, 2, 1] LPF (Low Pass filter).

Equations 10 and 11 show a procedure for deriving y[n] and z[n]. FIG. 28 represents h[n], y[n] and z[n], and a 8-tap SIF coefficient may be obtained through the linear interpolation of z[n] and a 1/32 fractional linear filter.

$$y [ n ] = h [ n ] * h [ n ] = {Σ}_{k = - 1}^{1} h [ k ] h [ n + k ] \qquad [ Equation 10 ]$$

$$z [ n ] = h [ n ] * y [ n ] = {Σ}_{k = - 1}^{1} h [ k ] y [ n + k ] \qquad [ Equation 11 ]$$

Equations 12 and 13 below describe a procedure for calculating a 8-tap SIF coefficient. Here, it may be g[n]=z[n−3], n=0, 1, 2, . . . , 6.

$${\sum }_{i = 0}^{6} g [ i ] ( \frac{32 - p}{32} r [ {i}_{0} + i ] + \frac{p}{32} r [ {i}_{0} + 1 + i ] ) ≪ 2 \qquad [ Equation 12 ]$$

Equation 13 shows an example in which a SIF coefficient is derived at a position of i₀+3+ 16/32 pixel when p is 16.

$$( \begin{matrix}\frac{16}{32} r [ {i}_{0} ] + \frac{112}{32} r [ {i}_{0} + 1 ] + \frac{336}{32} r [ {i}_{0} + 2 ] + \\ \frac{560}{32} r [ {i}_{0} + 3 ] + \frac{560}{32} r [ {i}_{0} + 4 ] + \frac{336}{32} r [ {i}_{0} + 5 ] + \\ \frac{112}{32} r [ {i}_{0} + 6 ] + \frac{16}{32} r [ {i}_{0} + 7 ]\end{matrix} ) ≪ 2 = ( \begin{matrix}2 r [ {i}_{0} ] + 14 r [ {i}_{0} + 1 ] + 42 r [ {i}_{0} + 2 ] + \\ 70 r [ {i}_{0} + 3 ] + 70 r [ {i}_{0} + 4 ] + 42 r [ {i}_{0} + 5 ] + \\ 14 r [ {i}_{0} + 6 ] + 2 r [ {i}_{0} + 7 ]\end{matrix} ) \qquad [ Equation 13 ]$$

FIG. 29 shows integer reference samples used to derive a 8-tap SIF coefficient. Referring to FIG. 29, 8 integer samples r[i₀]˜r[i₀+7] for deriving a filter coefficient for a black i₀+3+ 16/32 pixel position are indicated in gray. In addition, r[i₀] may be a start sample for 8 reference samples. A filter coefficient may be adjusted by integer implementation.

Since 8-tap DCT-IF has a higher frequency characteristic than 4-tap DCT-IF and 8-tap SIF has a lower frequency characteristic than 4-tap SIF, a 8-tap interpolation filter type may be selected and used according to the characteristic of a block.

The characteristic of a block may be determined by using the size of a block and the frequency characteristic of a reference sample and the type of an interpolation filter used for a corresponding block may be selected.

A characteristic may be used that as the size of a block is smaller, a correlation is lower and more frequencies are higher, as the size of a block is greater, a correlation is higher and more frequencies are lower.

### [Acquisition of Correlation]

In order to determine a reference sample characteristic based on a CU size, a correlation in Equation 14 is calculated from the top or left reference sample of a current CU according to an intra prediction mode. Here, N may be the width or height of a current CU.

$$correlation = \frac{{Σ}_{i = 0}^{N - 2} ( {x}_{i} - {x}^{\to } ) {( {y}_{i} - y )}^{\to } )}{\sqrt{{{Σ}_{i = 0}^{N - 2} ( {x}_{i} - {x}^{\to } )}^{2}} \sqrt{{{{Σ}_{i = 0}^{N - 2} ( {y}_{i} - y )}^{\to } )}^{2}}} \qquad [ Equation 14 ]$$

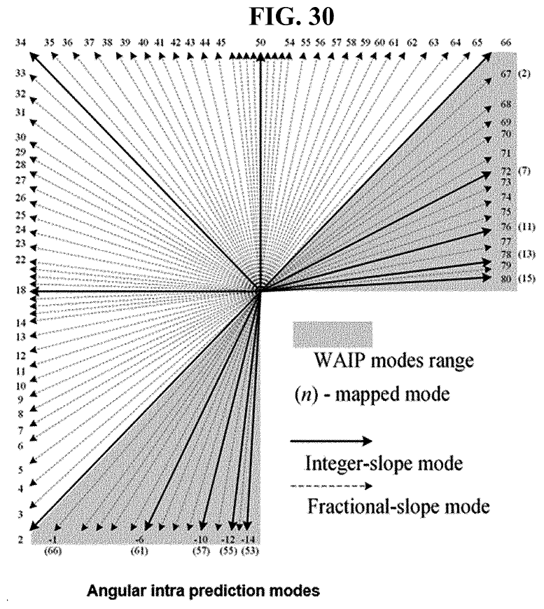

FIG. 30 is a diagram showing the direction and angle of an intra prediction mode. When the prediction mode of a current CU is greater than a diagonal mode 34 in FIG. 30, a reference sample at the top position of a current CU may be used in Equation 14. Otherwise, a reference sample at the left position of a current CU may be used in Equation 14.

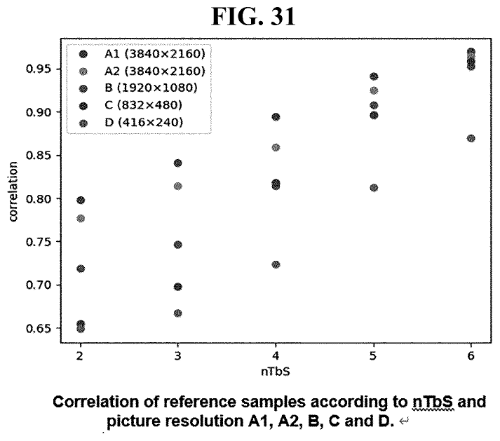

FIG. 31 is a diagram showing the average correlation value of a reference sample for a variety of video resolution and each nTbS. Specifically, FIG. 31 shows the average correlation value of reference samples for each nTbS and a variety of video resolution defined in Equation 15, which may be determined according to a CU size at each screen resolution. As in FIG. 31, a correlation may increase as a CU size increases and video resolution increases. Here, video resolution A1, A2, B, C and D may be shown in parentheses.

$$nTbS = ( ( Log 2 ( W ) + Log 2 ( H ) ) ≫ 1 \qquad [ Equation 15 ]$$

The intra CU size partition of video coding may depend on prediction performance for improving coding in terms of a bit rate and distortion. Prediction performance may vary depending on a prediction error between a prediction sample and the sample of a current CU. When a current block has many detailed regions including a high frequency, a CU size may be partitioned into small parts by considering a bit rate and distortion by using a boundary reference sample with a small width and height. However, when a current block is composed of homogeneous regions, a CU size may be partitioned into large parts by considering a bit rate and distortion by using a boundary reference sample with a large width and height.

Referring to FIG. 31, the correlation value of a reference sample according to video resolution and nTbS size indicated by A1, A2, B, C and D may be known. This may mean that small nTbS has a high-frequency characteristic consistent with a low correlation, and large nTbS has a low-frequency characteristic consistent with a high correlation, respectively.

The frequency characteristic of a reference sample may be obtained by using DCT-II to apply transform to the reference sample of a block. According to an intra prediction mode, a reference sample used to obtain the frequency characteristic of a reference sample may be determined. As an example, when the direction of an intra prediction mode is vertical, the top reference sample of a current encoding block (or sub-block) is used, and when the direction of an intra prediction mode is horizontal, the left reference sample of a current encoding block (or sub-block) is used. When the direction of an intra prediction mode is diagonal, at least one of the left or top reference sample of a current encoding block (or sub-block) is used. Here, a reference sample may be adjacent to a current encoding block (or sub-block) or may be k pixels away from a current encoding block (or sub-block). Here, k may be a natural number such as 1, 2, 3, 4, etc.

As a high frequency energy percentage is higher, a block may have a high frequency characteristic. The frequency characteristic of a block may be determined by comparing a high frequency energy percentage with a threshold according to a block size, and an interpolation filter to be applied to a block may be selected.

According to frequency information, 8-tap DCT-IF which is a strong high pass filter (HPF) may be applied to a block with many high frequencies, and 8-tap SIF which is a strong low pass filter (LPF) may be applied to a block with many low frequencies.

When a block size is small, 8-tap DCT-IF which is a strong HPF may be applied by using a method for applying a strong HPF to a block with many high frequencies according to frequency information and a characteristic that as a block size is smaller, a correlation is lower. When a high frequency is small, 4-tap SIF, which is a weak LPF may be applied.

When a block size is large, 8-tap SIF which is a strong LPF may be applied by using a method for applying a strong LPF to a block with many low frequencies according to frequency information and a characteristic that as a block size is larger, a correlation is higher. When there are many high frequencies, 4-tap DCT-IF which is a weak HPF may be applied.

An example for obtaining a high frequency energy percentage may be as follows.

When an intra prediction mode is horizontal, N is the height of a block, and when an intra prediction mode is vertical, N is the width of a block. When fewer or more reference samples are used, the value of N may be smaller or larger. X may refer to a reference sample. In this case, a high frequency domain uses a reference sample of ¼ the length of N, and the length of this domain may be decreased or increased when fewer reference samples are used to obtain high frequency energy or when more reference samples are used. Equation 16 may represent an example for obtaining a high frequency energy percentage.

$$high\_freq \_ratio = \frac{{Σ}_{k = N * 3 / 4}^{N - 1} X [ k ] * X [ k ]}{{Σ}_{k = 0}^{N - 1} X [ k ] * X [ k ]} * 100 \qquad [ Equation 16 ]$$

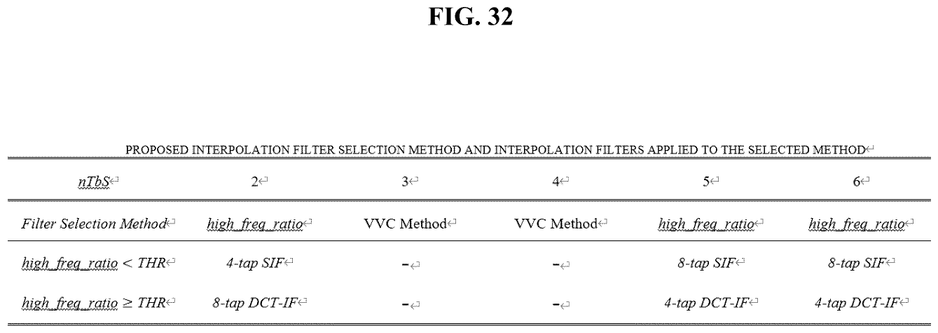

FIG. 32 shows an example of a method for selecting an interpolation filter by using frequency information.

When the high frequency energy percentage of a block with nTbS of 2 is less than a threshold, 4-tap SIF is applied, and otherwise, 8-tap DCT-IF is applied.

When the high frequency energy percentage of a block with nTbS of 5 or more is less than a threshold, 8-tap SIF is applied, and otherwise, 4-tap DCT-IF is applied.

Instead of the 8-tap filter, a filter such as 10-tap, 12-tap, 14-tap, 16-tap, etc. may be used.

In addition, each filter for nTbS and high_freq_ratio is described in FIG. 32, but a plurality of filters may be used.

As an example, when nTbS is 2, 4-tap SIF and 8-tap SIF may be used instead of 4-tap SIF. As an example, 8-tap DCT-IF and 16-tap DCT-IF may be used instead of 8-tap DCT-IF.

When a plurality of filters are used in this way, an encoding device may encode information (index) specifying any one of them, and a decoding device may signal the information from a bitstream to specify any one of the plurality of filters.

Alternatively, when a plurality of filters are used, any one of the plurality of filters may be implicitly specified by an intra prediction mode.

In addition, in determining a filter type, whether the shape of a block is square or rectangular may be additionally considered in addition to nTbS and high_freq_ratio.

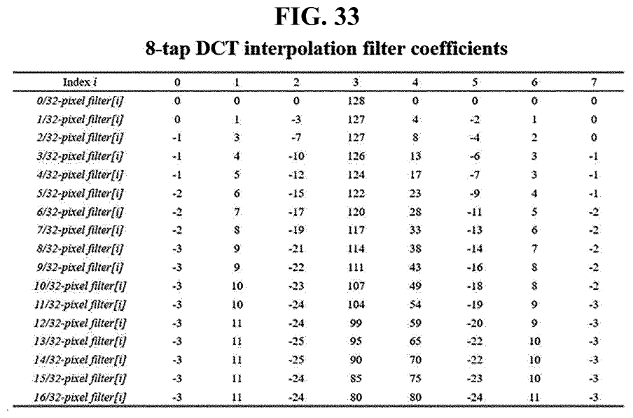

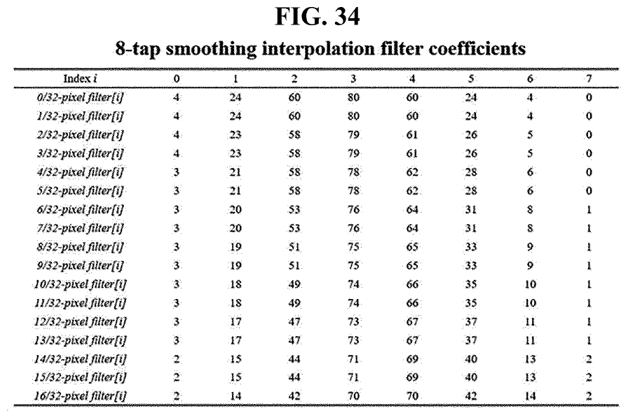

FIG. 33 shows embodiments for 8-tap DCT interpolation filter coefficients. FIG. 34 shows an embodiment for 8-tap smoothing interpolation filter coefficients. Here, index=0 and index=7 may correspond to 8 integer samples r[i₀]˜r[i₀+7] for deriving a filter coefficient.

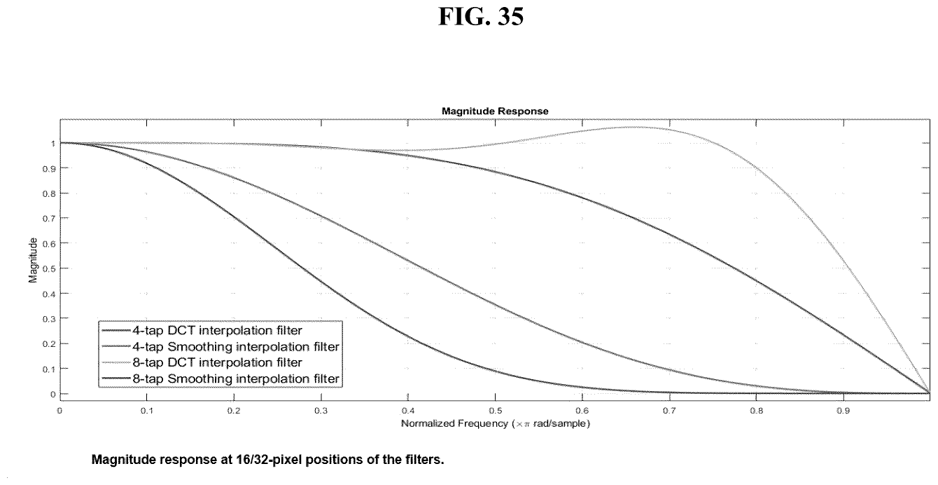

FIG. 35 shows a size response at a 16/32 pixel position of 4-tap DCT-IF, 4-tap SIF, 8-tap DCT-IF and 8-tap SIF. Here, a X-axis may represent a normalized radian frequency, and a Y-axis may represent a size response.

8-tap DCT-IF has a better HPF characteristic than 4-tap DCT-IF, and 8-tap SIF has a better LPF characteristic than 4-tap SIF. Accordingly, 8-tap SIF provides better interpolation than 4-tap SIF in a low-frequency reference sample, and 8-tap DCT-IF provides better interpolation than 4-tap DCT-IF in a high-frequency reference sample.

VVC uses two interpolation filters. When nTbS=2, 4-tap DCT-IF is used for all blocks, when nTbS=3, 4, 4-tap DCT-IF or 4-tap SIF is used based on minDist VerHor and intraHorVerDistThres[nTbS], and when nTbS≥5, 4-tap SIF is used for all blocks.

The present disclosure provides a method for selecting an interpolation filter for generating an accurate fractional boundary prediction sample by using frequency information of an integer reference sample, other than a proposed interpolation filter.

Although a CU reference sample has a low-frequency characteristic, DCT-IF is used for a CU reference sample with nTbS=2 in the VVC standard. However, as shown in FIG. 35, it may be more effective to use SIF than DCT-IF according to the low-frequency characteristic of a reference sample regardless of a nTbS size. Similarly, although a CU reference sample has a high-frequency characteristic, SIF is used for a CU with nTbS>4 in the VVC standard. However, it is more effective to use DCT-IF than SIF in FIG. 35 according to the high-frequency characteristic of a reference sample regardless of a nTbS size. To solve this problem, a method for selecting two different filters consisting of SIF and DCT-IF according to the frequency characteristic of a reference sample has been developed. A reference sample may be transformed by using a scaled integer one-dimensional (1-D) DCT-II kernel to detect the high-frequency energy of a reference sample. Scaled DCT-II coefficients X[k], k=0, 1, 2, . . . , N−1 are derived from Equations 17 and 18 as follows.

$$X [ k ] = ( {2}^{( 6 + M / 2 )} \sqrt{\frac{2}{N}} {Σ}_{n = 0}^{N - 1} {C}_{k} x ( n ) cos \frac{( n + \frac{1}{2} ) π k}{N} ) ≫ shift \qquad [ Equation 17 ]$$

$$M = {log}_{2} ( N ) , shift = {log}_{2} ( N ) + 1 \qquad [ Equation 18 ]$$

$${C}_{k} = \{ \begin{matrix}\frac{1}{\sqrt{2}} , k = 0 \\ 1 , k = 1 , 2 , … , N - 1\end{matrix}$$

Here, N is the number of reference samples required for X[k]. After one-dimensional transform, high-frequency energy is observed in a transform region. Since energy is concentrated on a low-frequency component, a reference sample consists of homogeneous samples. However, since energy exists in a high-frequency component, a reference sample includes a high-frequency sample, which shows that the sample of a CU has a high-frequency component. The transform size of a reference sample may be set according to the intra prediction mode of a current block. When an intra prediction mode is greater than mode 34 (diagonal mode), a top CU reference sample may be transformed to N=CU width in Equations 17 and 18. And, when an intra prediction mode is less than mode 34, a left reference sample may be used as N=CU height in Equations 17 and 18. X[k] may be used to measure the energy ratio of a high-frequency coefficient. When high-frequency data has energy, a reference sample consists of high-frequency data, so DCT-IF may be used. In contrast, SIF may be used for the high-energy reference sample of low-frequency data. high_freq_ratio, the energy percentage of a high-frequency coefficient, may be calculated in Equation 19.

$$high\_freq \_ratio = \frac{{Σ}_{k = N * 3 / 4}^{N - 1} X [ k ] * X [ k ]}{{Σ}_{k = 0}^{N - 1} X [ k ] * X [ k ]} * 100 \qquad [ Equation 19 ]$$

In FIG. 32, the threshold value (THR) of high_freq_ratio may be determined experimentally.

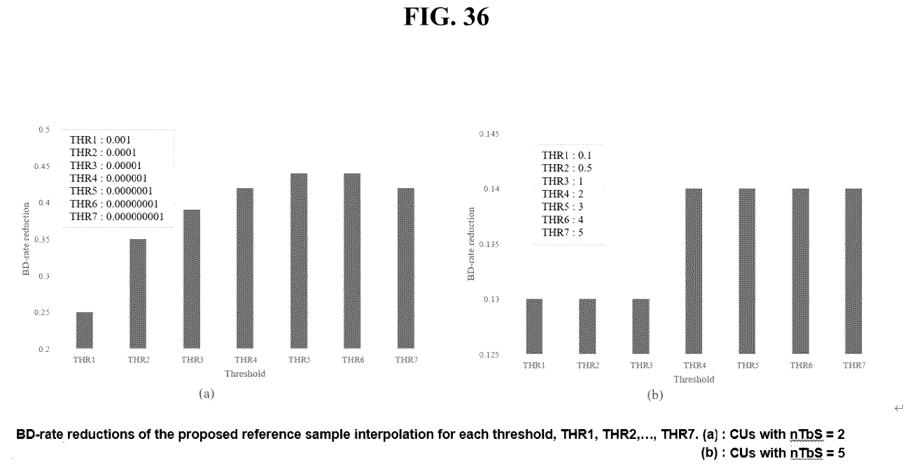

FIG. 36 shows each threshold value THR1, THR2, . . . according to nTbS, and FIG. 36(a) and FIG. 36(b) are a result of nTbS=2 and nTbS=5, respectively. In FIG. 36(a), 4-tap SIF may be used because high_freq_ratio is smaller than a given threshold value. Otherwise, 8-tap DCT-IF may be used. In FIG. 36(a), the most efficient BD-rate reduction occurs in THR5 and THR6. Accordingly, in this proposed method, THR5 may be selected as the THR of high_freq_ratio.

In FIG. 36(b), it may be confirmed that better coding efficiency is obtained in THR4 when an experiment is performed with high_freq_ratio when nTbS is 5 and a similar result is obtained when nTbS is 6. Accordingly, THR4 may be selected as THR when nTbS is 5 and 6. In a proposed method, for a CU with high_freq_ratio of nTbS>4, 8-tap SIF may be used when high_freq_ratio<THR. Otherwise, 4-tap DCT-IF may be used. For example, when a CU is 4×4, a nTbS value may be 2. 8-tap DCT-IF is used when high_freq_ratio>THR5 in FIG. 36(a). Otherwise, 4-tap SIF is used for a CU. A proposed method depends on nTbS and high_freq_ratio. When the nTbS size of a CU is 2, if high_freq_ratio<THR, 4-tap SIF with a weak LPF characteristic is applied to a reference sample as in FIG. 35. Otherwise, if high_freq_ratio≥THR, 8-tap DCT-IF with a strong HPF characteristic is applied to a reference sample as in FIG. 35.

Similarly, when the nTbS size of a CU is greater than 4, if high_freq_ratio<THR, 8-tap SIF with a strong LPF characteristic may be applied to a reference sample as in FIG. 35. As in FIG. 36, when nTbS>4, it may be relatively higher than when nTbS=2. Otherwise, if high_freq_ratio>THR, 4-tap DCT-IF with a weak HPF characteristic may be applied to a reference sample as in FIG. 35.

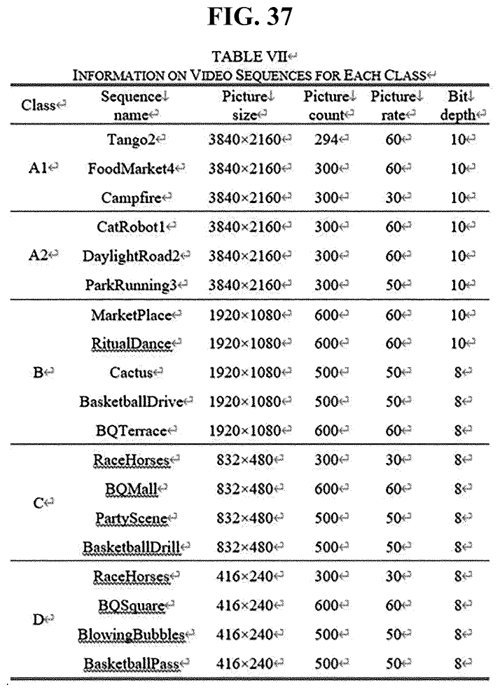

FIG. 37 shows the sequence name, screen size, screen rate and bit depth of a CTC video sequence for each class.

A proposed method was implemented in VTM-14.2 [37], VVC reference software, and was tested in an All Intra (AI) configuration under JVET Common Test Conditions (CTC) [38]. Each sequence of classes A1, A2, B, C and D was tested with s quantization parameter (QP) value of 22, 27, 32 and 37, respectively.

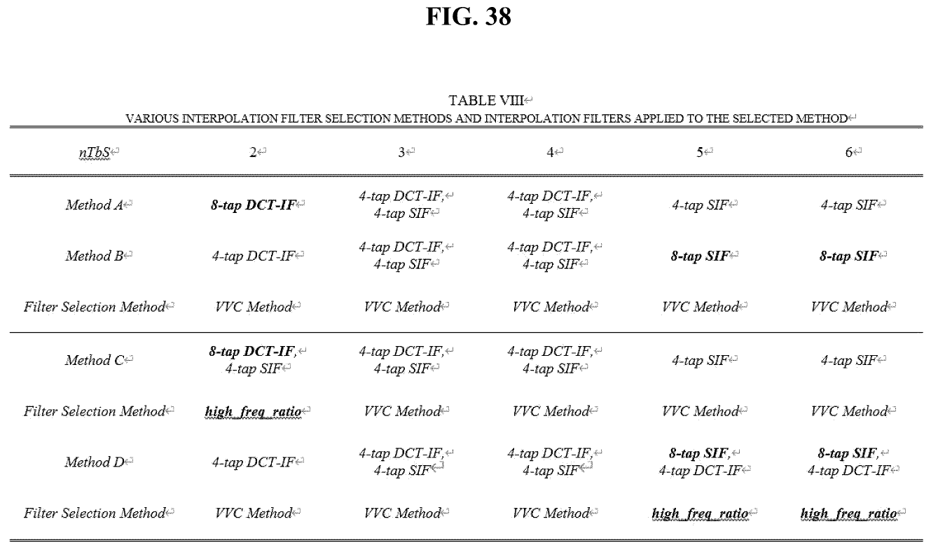

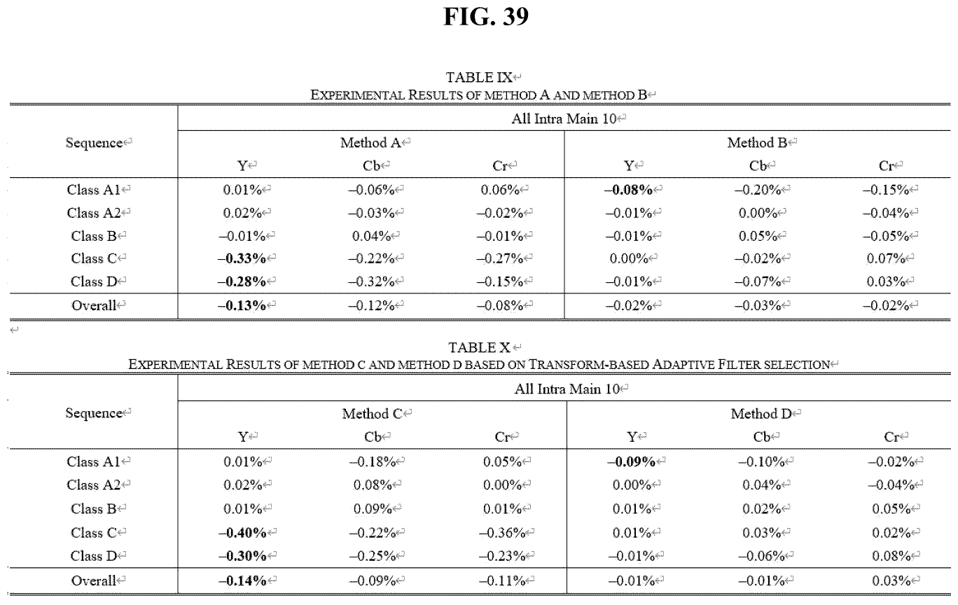

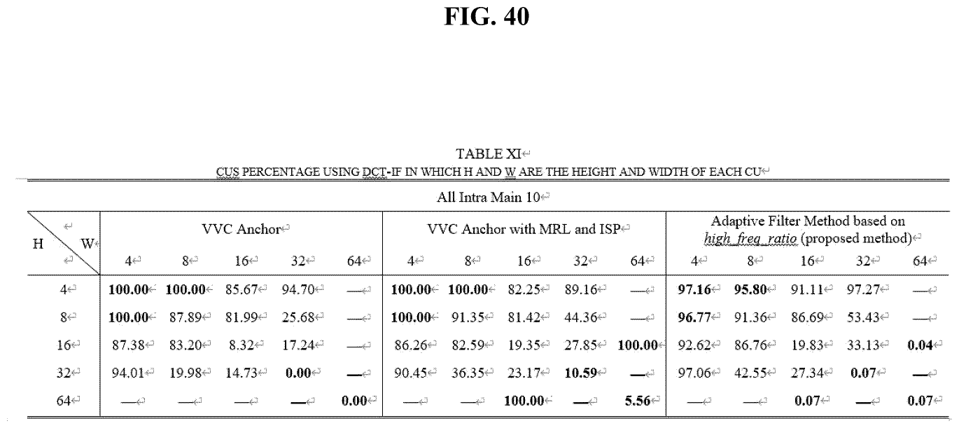

FIG. 38 shows an interpolation filter selection method and an interpolation filter applied according to a selected method to test the efficiency of a 8-tap/4-tap interpolation filter.

Method A uses 8-tap DCT-IF for nTbS=2 and 4-tap SIF for nTbS>4, and Method B uses 8-tap SIF for nTbS>4, uses 4-tap DCT-IF for nTbS=2 and selects DCT-IF or SIF in the same way as a VVC anchor. A difference between Method A and a VVC method is that Method A uses 8-tap DCT-IF instead of 4-tap DCT-IF only for nTbS=2. A difference between Method B and a VVC method is that Method B uses 8-tap SIF instead of 4-tap SIF only for nTbS>4.

Table IX and Table X in FIG. 39 show a simulation result from methods A, B, C and D.

Method C uses 8-tap DCT-IF or 4-tap SIF according to high_freq_ratio in Equation 19 for nTbS=2 and 4-tap SIF for nTbS>4. Method D uses 8-tap SIF or 4-tap DCT-IF. It depends on high_freq_ratio for nTbS>4 and depends on 4-tap DCT-IF for nTbS=2. Here, a filter selection method and an interpolation filter are used for a CU of nTbS=3 and nTbS=4 in a VVC anchor.

For Method A, an overall increase in a BD-rate of −0.13%, −0.12% and −0.08% is observed for Y, Cb and Cr components, respectively, where a sign (−) refers to bit saving. For Method C, an overall increase in a BD rate of −0.14%, −0.09% and −0.11% is observed for Y, Cb and Cr components, respectively.

In particular, for class C with resolution of 832×480 and class D with resolution of 416×240, component gains (−0.40%, −0.30%) from methods A and Y and classes C and D are achieved by Method C. For Methods A and C, 8-tap DCT-IF for nTbS=2 and SIF for nTbS>4 are applied to each CU regardless of a filter selection method.

For Method B, all BD-rate gains are −0.02%, −0.03% and −0.02% for Y, Cb and Cr components, respectively. For Method D, all BD-rate gains are −0.01%, −0.01% and −0.03% for Y, Cb and Cr components, respectively.

Method B uses 8-tap SIF for nTbS>4 and uses 4-tap DCT-IF for nTbS=2, and Method D uses 8-tap SIF or 4-tap DCT-IF according to high_freq_ratio proposed for nTbS>4 and uses 4-tap DCT-IF for nTbS=2.

There is little overall increase in a BD rate in Methods B and D, but an increase in a BD rate (−0.08%, −0.09%) is obtained from the Y component of class A1 with resolution 3840×2160 in Methods B and D, respectively. The proposed frequency-based adaptive interpolation filtering using high_freq_ratio and nTbS and the existing VVC method have been developed to utilize Methods C and D.

Table XI in FIG. 40 shows the ratio of a CU that applies 4-tap DCT-IF at a VVC anchor and applies 8-tap DCT-IF based on high_freq_ratio in a method proposed for all test sequences.

For nTbS=2, 4-tap DCT-IF is selected 100% in the 4×4 CU, 4×8 CU and 8×4 CU of a VVC anchor, while 8-tap DCT-IF is selected 97.16% in a 4×4 CU, 95.80% in a 4×8 CU and 96.77% in a 8×4 CU in a proposed adaptive filter method based on high_freq_ratio. The percentage of a 4-tap SIF selection with nTbS=2 may be inferred from the DCT-IF selection percentage in Table XI.

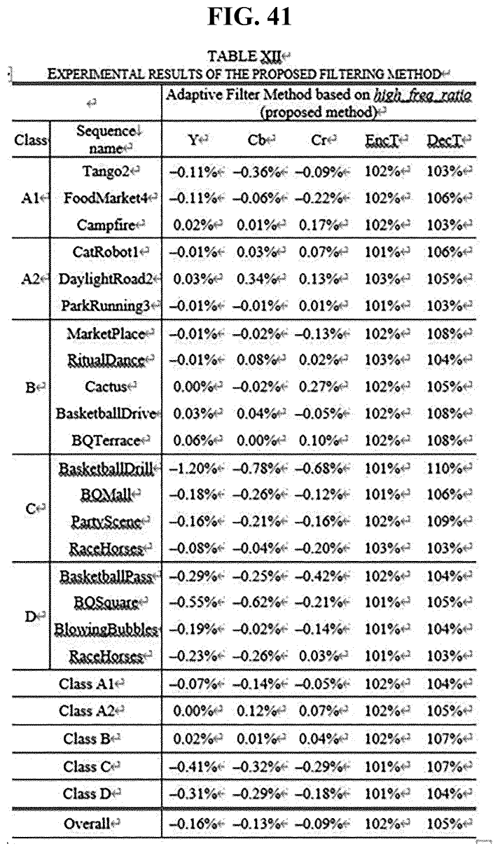

FIG. 41 shows an experimental result for a proposed filtering method.

A percentage selection increase in 4-tap SIF and 8-tap DCT-IF brings BD rate gain from Table XII. When 4-tap SIF with a low LPF characteristic and 8-tap DCT-IF with a strong HPF characteristic are used according to high_freq_ratio of a small CU, it is helpful to increase a BD rate in a proposed method. And, when 8-tap SIF with a strong LPF characteristic and 4-tap DCT-IF with a bad HPF characteristic are used according to high_freq_ratio of a large CU, it is helpful to increase a BD rate slightly in a proposed method.

Except for nTbS>4, 4-tap DCT-IF is applied only to a CU using a MRL or ISP tool in a VVC anchor.

However, high_freq_ratio-based 8-tap DCT-IF and 4-tap SIF are applied to a CU using MRL or ISP in a proposed method, so 8-tap DCT-IF is selected 0.07% in a 32×32 CU, 0.04% in a 16×64 CU, 0.07% in a 64×16 CU and 0.07% in a 64×64 CU. This is compared to a case in which it is selected 10.59% in a 32×32 CU of a VVC anchor, 100% in a 16×64 CU, 100% in a 64×16 CU and 5.56% in a 64×64 CU.

Table XII shows a result of a proposed adaptive filter method based on high_freq_ratio, and in an AI Main 10 configuration, EncT and DecT represent the total encoding and decoding time rate compared to a VVC anchor for various test sequences in classes A1 to D, respectively.

A proposed method may achieve an overall BD rate increase of −0.16%, −0.13% and −0.09% for Y, Cb, and Cr components, respectively, and computational complexity increases by 2% and 5% on average compared to a VVC anchor in an encoder and a decoder, respectively.

With a slight increase in computational complexity, a proposed method may be used to reduce a BD rate compared to a VVC anchor. A sequence that shows the highest BD rate reduction is a BasketballDrill sequence from Class C, and a proposed method produces a Y component gain of −1.20%.

In conclusion, the present disclosure proposes an adaptive filter method for generating a partial reference sample for directional VVC intra prediction. In order to improve the precision of a fractional reference sample by using high_freq_ratio derived from 1D scaled DCT, 8-tap DCT-IF and 8-tap SIF are proposed in addition to 4-tap DCT-IF and 4-tap SIF. Depending on high_freq_ratio for a block size, an interpolation filter is applied to a reference sample. It was concluded that when a correlation between samples is high, a 8-tap interpolation filter with strong HPF or strong LPF has a minimal effect on a BD rate gain, but when a correlation between samples is low, a strong 8-tap interpolation filter is used. A HPF or strong LPF characteristic affects BD rate improvement. For a proposed adaptive filter method based on high_freq_ratio, the overall BD rate gains of −0.16%, −0.13% and −0.09% are observed for Y, Cb and Cr components, respectively, compared to a VVC anchor. A method for searching for high frequency terms in a frequency domain is helpful for a video coding module that requires strong/weak HPF and strong/weak LPF for the next-generation video coding standards.

The scope of the present disclosure includes software or machine-executable instructions (e.g., an operating system, an application, firmware, a program, etc.) that causes an operation according to a method from various embodiments to be executed on a device or a computer, and a non-transitory computer-readable medium where such software or instructions, etc. are stored and executable on a device or a computer.

### INDUSTRIAL AVAILABILITY

The present invention may be utilized as a video encoding and decoding device and method.

1. An image decoding method, comprising:
dequantizing a quantization block obtained from a bitstream to obtain a secondary transform block;
determining whether to perform a secondary inverse transform for the secondary transform block;
when it is determined to perform the secondary inverse transform, performing the secondary inverse transform for the secondary transform block to obtain a primary transform block; and
performing a primary inverse transform for the primary transform block.

2. The method of claim 1, wherein:
a transform kernel of the secondary inverse transform and a transform kernel of the primary inverse transform are specified by an index signaled from the bitstream.

3. The method of claim 1, wherein:
a maximum value and a configuration of the index are different depending on whether a transform kernel applied is a one-dimensional transform kernel or a two-dimensional transform kernel.

4. The method of claim 1, wherein:
a transform kernel of the secondary inverse transform and a transform kernel of the primary inverse transform include a Karhunen Loeve Transform (KLT).

5. The method of claim 1, wherein:
an output block of at least one of the secondary inverse transform or the primary inverse transform has a size smaller than a size of an input block.

6. An image encoding method, comprising:
performing a primary transform on a residual block to obtain a primary transform block;
determining whether to perform a secondary transform on the primary transform block;
when it is determined to perform the secondary transform, performing the secondary transform to obtain a secondary transform block; and
encoding a quantization block obtained by quantizing the secondary transform block in a bitstream.

7. (canceled)

8. (canceled)

9. (canceled)

10. (canceled)

11. (canceled)

12. (canceled)

13. (canceled)

14. (canceled)

15. A non-transitory computer readable recording medium storing a bitstream generated by an encoding method, wherein the encoding method includes:
performing a primary transform on a residual block to obtain a primary transform block;
determining whether to perform a secondary transform on the primary transform block;
when it is determined to perform the secondary transform, performing the secondary transform to obtain a secondary transform block; and
encoding a quantization block obtained by quantizing the secondary transform block in the bitstream.
